(19) United States
(12) Patent Application Publication
(10) Pub. No.: US 2026/0130568 A1
(43) Pub. Date: May 14, 2026

(54) CLEANING PRODUCT HAVING NONFIBROUS POLYMERIC ELEMENTS

(71) Applicant: The Procter & Gamble Company, Cincinnati, OH (US)

(72) Inventors: Karen Aida MARTINEZ DE LEON, Hamilton, OH (US); Nayda Liz RAMOS MEDINA, Green Township, OH (US)

(21) Appl. No.: 18/941,125

(22) Filed: Nov. 8, 2024

(51) Int. Cl. A47L 13/24; D04H 1/4374; D06M 23/16

(52) U.S. Cl. CPC A47L 13/24; D04H 1/4374; D06M 23/16; D10B 2509/00

(57) ABSTRACT

A cleaning product. The cleaning product includes a first nonwoven. A first plurality of nonfibrous polymeric elements that constitutively differs from the first nonwoven is engaged with the first nonwoven. Members of the first plurality of nonfibrous polymeric elements project outwardly away from the first nonwoven. Members of the first plurality of nonfibrous polymeric indicia are sized and dimensioned to provide a pattern created volume of from about 0.2 mm to about 1 mm. An adhesion agent is carried by the first nonwoven. The adhesion agent is selected from the group of oil, wax, adhesive, and combinations thereof.

### FIELD OF THE INVENTION

Nonwoven cleaning products for surfaces.

### BACKGROUND OF THE INVENTION

A variety of cleaning products for cleaning and removing dust from household surfaces are available to consumers. These cleaning products are typically built from one or more layers of nonwoven fibrous webs. These layers are typically flat nonwovens that present to the surface being wiped a uniform surface having a degree of nonuniformity, or roughness, inherent to the structure of the nonwoven per se. Designers may choose the characteristics of the nonwoven based on the type of surface to be wiped and the type of detritus that is to be removed from such surface. Characteristics including, but not limited to, the constituent material of the fibers, the shape of the fibers, the denier of the fibers, and the basis weight of the nonwoven may be given consideration in designing the wipe.

When it comes to soiled household surfaces, the reality is that there may be a wide range of detritus that is to be removed from the surface being cleaned. Uniform nonwoven materials used in cleaning products may be tuned to most effectively remove only a subset of that range. That can lead to users of the wipes being dissatisfied with the performance of the cleaning product across a wide range of detritus.

Some cleaning products are fabricated to have some degree of three dimensional profile beyond the roughness of a nonwoven that is inherent to the nonwoven being a fibrous structure. For example, cleaning products may be needle punched or otherwise deformed in a solid state to create a three dimensional profile that is tufted or has raised portions. When cleaning products are packaged, it is common to try to minimize the volume of the package by packing the cleaning products tightly within the package. Unfortunately, the tight packaging can collapse the three dimensional profile to some degree such that when the user withdraws a cleaning product from the package, the cleaning product may not have as diverse a surface profile as might be desired.

With the above limitations in mind, there is a continuing unaddressed need for cleaning products that have a durable three dimensional surface profile.

### SUMMARY OF THE INVENTION

A cleaning product comprising: a first nonwoven; a first plurality of nonfibrous polymeric elements that constitutively differs from said first nonwoven, wherein members of said first plurality of nonfibrous polymeric elements are engaged with said first nonwoven and project outwardly away from said first nonwoven, and wherein members of said first plurality of nonfibrous polymeric indicia are sized and dimensioned to provide a pattern created volume from about 0.2 mm to about 1 mm; and an adhesion agent carried by said first nonwoven, wherein said adhesion agent is selected from the group of oil, wax, adhesive, and combinations thereof.

### BRIEF DESCRIPTION OF THE DRAWINGS

FIG. 1 is a top view of a cleaning product.

FIG. 2 is a top view of part of a cleaning product.

FIG. 3 is a profile view of part of a cleaning product.

FIG. 4 is profile view of part of a cleaning product.

FIG. 5 is a perspective view of a portion of a cleaning product.

FIG. 6 is a profile view of a cleaning product.

FIG. 7 is a top view of part of a cleaning product.

FIG. 8 is a profile view of a cleaning product.

FIG. 9 is a top view of a portion of a cleaning product.

FIG. 10 is a top view of portions of a cleaning product.

FIG. 11 is a partially folded cleaning product.

FIG. 12 is a top view of a cleaning product.

FIG. 13 is a cleaning product engaged with a handle.

FIG. 14 is a bottom view of a cleaning product that includes a backsheet and attachment strips.

FIG. 15 is a top view of a cleaning product.

FIG. 16 is an array of cleaning products.

FIG. 17 is an array of cleaning products.

### DETAILED DESCRIPTION OF THE INVENTION

### Nonwovens

The nonwoven fibrous webs, also referred to more simply as nonwovens, described herein can be spun bonded, carded, hydroentangled spun bonded, melt blown, coformed, wet laid, air laid nonwovens, or combinations thereof. The nonwovens can be microfiber nonwovens comprising microfibers, which may provide for one or more of dust, soil, or liquid acquisition. The fibers constituting the nonwoven can be natural or synthetic fibers. The fibers constituting the nonwovens can be selected from, or selected from the group of, or selected from the group consisting of cellulose, polypropylene, polyethylene, polyester, and combinations thereof. The fibers constituting the nonwovens can be natural fibers or synthetic fibers. The nonwovens can be hydrophilic nonwovens so that liquid can be acquired from the floor being cleaned. One or more of the nonwovens can comprise bicomponent fibers having a sheath of polyethylene and a core of polyester. The nonwovens described herein can be bicomponent thermoplastic synthetic fibers of an outer sheath of polyester and polyethylene core. The basis weight of each nonwoven can be from about 5 to about 500 g/m², optionally from about 10 to about 120 g/m², optionally from about 15 to about 70 g/m², optionally from about 20 to about 50 g/m². The nonwovens described herein can be mixture of hydrophilic and hydrophobic fibers, for example a mixture of cellulose fibers and polyethylene or polypropylene fibers. The nonwovens described herein, including those that include hydrophilic fibers as a fraction of the fiber makeup, can be homogeneously mixed and be made by carded thermal bonding, thru-air bonding, spun lacing, or be wet laid. The nonwovens described herein can be laminates of synthetic fibers and natural fibers, for example a cellulosic tissue sandwiched between layers of synthetic fibers. The fibers of the nonwovens described herein may be coated with wax or oil to increase the ability of such coated fibers to retain solids gathered by the fibers. The nonwovens can be an about 20 g/m² to about 70 g/m² microfiber nonwoven, optionally about 60 wt % to about 80 wt % polyethylene terephthalate and 20 wt % to about 40 wt % nylon 6. Optionally, the microfiber can be a microfiber comprising about 70 wt % polyethylene terephthalate and about 30 wt % nylon 6.

Suitable nonwovens can include a nonwoven material having a basis weight from about 20 g/m² to about 150 g/m², optionally from about 20 g/m² to about 70 g/m². The nonwoven materials can comprise a combination of pulp/tissue and spun bond polypropylene hydroentangled to the pulp in a wet laid process. Optionally, one or more of the nonwovens can comprise from about 10 g/m² to about 40 g/m² pulp/tissue and from about 10 g/m² to about 30 g/m² spun bond polypropylene hydroentangled to the pulp. The thickness of each of the nonwoven materials can be from about 300 to about 600 microns. Optionally, one or more of the nonwovens can comprise about 23 g/m² of pulp/tissue and about 17 g/m² spun bond polypropylene hydroentangled with the pulp in a wet laid process. Suitable nonwovens include 30 g/m² to 70 g/m², optionally 40 g/m², GENESIS nonwoven available from Suominen, Helsinki, Finland. The nonwoven can comprise a hydroentangled spun bond nonwoven having a basis weight from about 20 g/m² to about 80 g/m².

Suitable nonwovens can also include hydroentangled spun lace nonwovens ranging in basis weight from about 20 g/m² to about 150 g/m², optionally from about 20 g/m² to about 80 g/m². The nonwoven materials can comprise a combination of polyethylene terephthalate, natural fibers, regenerated cellulose fibers, pulp, polypropylene, polyethylene fibers that are hydroentangled. The nonwoven material can be flat or be provided with an added three-dimensional structure while being hydroentangled or after hydroentangling. One example from Spuntech Industries Inc, is a 60 g/m² flat hydroentangled nonwoven with 100% carded polyethylene terephthalate fibers. Another example is a 60 g/m² flat hydroentangled spun lace with 70% carded polyethylene terephthalate fibers and 30% carded viscose fibers. Another suitable nonwoven is a 58 g/m² material that might be flat or might be an embossed hydroentangled non-woven made from about 1.7 DTEX round polyester staple fibers round polyester staple fibers (outer layers) with a spun bond nonwoven layer in the middle of about 2.2 DTEX round polypropylene fibers. This nonwoven can have a thickness from about 1 to about 2 mm sold by Suominen of Helsinki, Finland.

A nonwoven suitable for the intermediate layer could be a spun bond nonwoven. The basis weight of the spun bond nonwoven can be from about 10 to about 150 g/m², optionally from about 15 to about 90 g/m², optionally from about 20 to about 70 g/m². The nonwoven could have mono component or bicomponent fibers. One example of could be a 25 g/m² bicomponent spun bond sourced from Fitesa Inc. consisting of fibers with a sheath to core ratio of 40% to 60% polyethylene. Another example could be a 25 g/m² bicomponent spun bond with a 40% to 60% polyester by weight with color pigment in the core. The nonwoven can comprise color inside the fiber, in the core, in the sheath or both.

The nonwoven materials can comprise a bicomponent fiber comprising 1.7 DTEX round polyester staple fiber sheath and a 2.2 DTEX round spun bond polypropylene fiber core. The nonwoven materials can have a thickness from about 0.5 mm to about 4 mm, optionally from about 1 mm to about 2 mm. Optionally the nonwoven materials can comprise 50% by weight or more polyethylene terephthalate. The nonwoven can comprise a laminate of nonwovens. For example two or more plies of nonwoven can be facingly joined together by an adhesive, mechanical bonds, and or thermal bonds.

Optionally, the nonwoven can have a plastic content from about 0% to about 10% by weight of the nonwoven.

Suitable nonwovens include those used in SWIFFER DUSTER, SWIFFER DUSTER HEAVY DUTY, SWIFFER POWEMOP mop pads, SWIFFER WETJET dry mop pads, SWIFFER WETJET HEAVY DUTY mop pads, SWIFFER SWEEPER WET pads, SWIFFER SWEEPER DRY pads, and SWIFFER HEAVY DUTY wet cloths, available from The Procter & Gamble Company as of or prior to the effective filing date of this patent application.

### Nonfibrous Polymeric Elements

The nonfibrous polymeric elements can be ink. The ink can be a water based ink. The ink can comprise a thermoplastic material as a basis material. The ink can comprise one or more of polyacrylate, polyurethane, and polyester. Optionally, the ink can comprise a crosslinking agent. The ink optionally may include fine solid material. The ink may also comprise a colorant such as a pigment or dye to render the nonfibrous polymeric elements to be visible to a human under household lighting conditions. The polymeric elements can contrast in color with the substrate with which they are engaged. That can help the user of the cleaning products described herein recognize that the nonfibrous polymeric elements are present so that the benefit of the nonfibrous polymeric elements can be achieved by or recognized by the user of the cleaning product.

The ink can comprise an acrylic copolymer of styrene, butyl acrylate, and acrylonitrile; and an acrylic copolymer of styrene, butyl acrylate, ethyl acrylate, and acrylic acid. Optionally, the ink can further comprise one or more of a crosslinking agent, a rheology modifier, and an emulsifier. The ink can further comprise one or more of polyacrylic acid ammonium salt thickener, urea, diethylene glycol, polyethoxylated fatty alcohol, polyethoxylated isotridecanol, polyethoxylated stearyl alcohol, sodium laurel sulfate, polydimethylsiloxane, silica, oxidized aliphatic hydrocarbon, sodium benzoate, methyl isothiazolinone, methylchloroisthiazolinone, and trimethylolpropane tris-2-methyl-1-aziridinepropionate.

Optionally, the ink, as applied to the nonwoven, can be a water-based ink. The ink can optionally comprise a puffing agent. The puffing agent can be encapsulated gas, for example isobutane. The ink can be a water based ink comprising an expandable encapsulated gas, optionally configured in a manner to be a heat expandable gas. When printed the encapsulates of gas can have a diameter from about 5 mm to about 200 mm. When an ink containing a puffing agent is heated, the encapsulates expand. When the ink is dried with the puffing agent in an expanded state, the solid structure of the dried ink locks the expanded puffing agent in place, thereby forming a porous ink, also sometimes referred to as a puffed ink in the art of screen printing. The ink can be formulated and applied as described in U.S. Pat. No. 8,821,979 B2 and WO2004/071780 A2.

The ink can be applied to the nonwoven and then dried by heating. The resulting nonfibrous polymeric elements can have any desired shape that can be applied by screen printing or other suitable methods for printing nonwovens. The nonfibrous polymeric elements can be applied to the nonwoven by spraying, flexographic printing, screen printing, or digital printing, by way of nonlimiting example.

The nonfibrous polymeric elements, as viewed in plan view on a printed surface of the nonwoven, can be solid circles or approximate circles having a diameter from about 0.1 mm to about 3 mm. Optionally, the nonfibrous polymeric elements may protrude above the thickness of the nonwoven by 0.01 mm to about 2 mm, optionally by 0.2 mm to about 0.5 mm. The portion of individual nonfibrous polymeric elements protruding above the surface of the nonwoven may be dome shaped, for example a rounded section of a hemisphere, approximate hemisphere, oblate hemisphere, or other rounded section or partially flattened round section. The nonfibrous polymeric elements can be spaced apart from one another, optionally by a distance from about 1 mm to about 5 mm, optionally from about 1 mm to about 3 mm. Individual nonfibrous polymeric elements can have a footprint, that is a planar area or a bearing area, on or in the material with which they are engaged that is from about 0.5 mm² to about 8 mm², optionally from about 0.7 mm² to about 5 mm², optionally from about 0.7 mm² to about 3 mm². The nonfibrous polymeric elements can be discrete nonfibrous polymeric elements that are spaced apart from one another.

The nonfibrous polymeric elements can have other shapes in plan view, including but not limited to, solid or open squares, rectangles, triangles, diamonds, stars, and the like, rings, straight lines, curved lines, and compound lines, and combinations thereof. The polymeric elements can be arranged in a pattern comprising repetitive shapes or a combination of shapes. The polymeric elements can be a pattern of spaced apart solid circles. The pattern can be a space centered pattern or node centered pattern, or other repetitive arrangement or mathematically describable pattern. The nonfibrous polymeric elements can be arranged randomly. The nonfibrous polymeric elements can be spaced apart from one another. Optionally, the nonfibrous polymeric elements can be spaced apart from one another by a distance greater than the maximum dimension, optionally the maximum in plane dimension with the plane being parallel to a plane defined by the longitudinal axis and transverse axis, of the individual nonfibrous polymeric elements per se.

The solid nature of the nonfibrous polymeric elements can be more durable to compression forces than a nonwoven that is deformed to have a three dimensional surface profile. The three dimensionality of a formed nonwoven is prone to some degree of collapse, for example in use or while tightly packed in a package. The rigidity of the solid nonfibrous polymeric elements can provide for a durable three dimensional surface profile for the cleaning product that is maintained during packing, storing, and use of the cleaning product that includes the nonfibrous polymeric elements.

### Tow Fibers

Tow fibers are a group or bundle of predominantly untwisted generally aligned fibers cut from an untwisted bundle of continuous fibers, each of the fibers having distinct endpoints and having a length greater than about 0.01 m, optionally greater than about 0.03 m, optionally greater than about 0.05 m, optionally from about 0.01 m to about 0.4 m, optionally from about 0.02 m to about 0.2 m, optionally from about 0.05 m to about 0.2 m. The tow fibers may be of natural or synthetic origin. The tow fibers can comprise polymers including, but not limited to, polyester, polypropylene, polyethylene, nylon, rayon, polylactic acid, biopolyethylene, biopolyester, cellulose, cellulose acetate, flax, hemp, jute, and combinations thereof. The tow fibers can be bicomponent fibers having a polypropylene or polyethylene core and a polyethylene sheath. The tow fibers can be the same as those used as a component of SWIFFER DUSTERS available from The Procter & Gamble Company as of or prior to the effective filing date of this patent application. The tow fibers may be straight fibers, crimped fibers, or otherwise shaped fibers that are generally aligned with one another. Tow fibers are recognized as being effective at collecting dust and debris when fluffed.

The tow fibers can have a fineness from about 1 to about 50 dtex, optionally from about 2 dtex to about 10 dtex. The tow fibers can be a mixture of fibers of different fineness.

Tow fibers can be provided as a layer of constituent tow fibers in which the constituent tow fibers are substantially aligned with one another. A tow fibers layer can comprise constituent tow fibers that are stacked on top of one another or otherwise layered upon on another such that a tow fibers layer is a mat of constituent tow fibers having a thickness greater than the fineness of the constituent tow fibers. A tow fibers layer can include constituent tow fibers of varying fineness and or variable fineness along individual constituent tow fibers.

### Adhesion Agent

The nonwoven and or tow fibers may carry an adhesion agent. The adhesion agent can be selected from, selected from the group of, or selected from the group consisting of oil, wax, adhesive, and combinations thereof. The adhesion agent can coat the fibers constituting the nonwoven or tow fibers. The adhesion agent can be mineral oil. The adhesion agent can be mixture of mineral oil and surfactant, optionally a nonionic surfactant, at a ratio of about 90 mineral oil to 10 surfactant.

The adhesion agent may be carried by the constituent fibers of the nonwoven and tow fibers in an amount that is from about 1% to about 20% by dry weight of the constituent fibers carrying the adhesion agent.

The adhesion agent can be helpful with capturing dust and debris.

### Absorbent Core

Some cleaning products can include an absorbent core. The absorbent core can be an air laid core. The absorbent core can comprise cellulose fibers. Optionally, the absorbent core can comprise absorbent gelling material. The absorbent core can comprise multiple plies of materials including layers of foam, wet laid cellulose fibers, air laid cellulose fibers, tissue, polypropylene spun bond nonwoven, polyester fibers, bicomponent cellulose and synthetic fibers, and the like.

The absorbent core can comprise a bicomponent cellulose/synthetic air laid material. The absorbent core can comprise an air laid composite that is about 85:15 cellulose: bicomponent fibrous material. The absorbent core can be a mixture of cellulose fibers and synthetic fibers, with cellulose fibers constituting from about 5 wt % to about 100 wt % of the absorbent core. The absorbent core can have a basis weight from about 60 g/m² to about 500 g/m², optionally from about 60 g/m² to about 200 g/m², optionally any range within the aforesaid ranges. The absorbent core can be an air laid composite that is 85:15 cellulose: bicomponent fibers having a basis weight of about 135 g/m².

An absorbent core can be helpful for storing liquid surface treatment composition, acquiring spent liquid surface treatment composition from the surface being cleaned, as well as be helpful for acquiring and storing detritus from the surface being cleaned.

### Surface Treatment Composition

The surface treatment composition can be a liquid composition that helps to clean the floor. The surface treatment composition can comprise a surfactant. The surfactant can be a nonionic surfactant, an anionic surfactant, a cationic surfactant, and mixtures thereof. The surface treatment composition can comprise about 99.93% by weight of the surface treatment composition water, and optionally about 0.04% by weight of the surface treatment composition surfactant, and optionally about 0.03% by weight of the surface treatment composition perfume. Alternatively, the surface treatment composition can comprise at least about 80% by weight of the surface treatment composition water, at least 0.04% by weight of the surface treatment composition surfactant, and at least 0.03% by weight of the surface treatment composition perfume. Optionally, the surface treatment composition can comprise from about 80% to about 99.95% by weight of the surface treatment composition water, from about 0.02% to about 0.06% by weight of the surface treatment composition surfactant, and about 0.01% to about 1% by weight of the surface treatment composition perfume. Optionally the surface treatment composition can comprise from about 0.01% to about 4% by weight of the surface treatment composition surfactant. Optionally, the surface treatment composition can comprise from about 0.01% to about 2% by weight of the surface treatment composition surfactant. Optionally the surface treatment composition can comprise from about 0.01% to about 1% by weight of the surface treatment composition surfactant. Optionally the surface treatment composition can comprise from about 0.01% to about 0.1% by weight of the surface treatment composition surfactant. The surfactant can be a nonionic surfactant, an anionic surfactant, a cationic surfactant or a mixture thereof.

The surface treatment composition can also comprise more than about 80% by weight of the surface treatment composition water; less than 3% by weight of the surface treatment composition solvent, the solvent being selected from the group of glycol ethers, glycol phenol ethers, alcohols, mono-propylene glycol mono-propyl ether, di-propylene glycol mono-propyl ether, mono-propylene glycol mono-butyl ether, di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether and di-ethylene glycol mono-hexyl ether, and mixtures thereof. The surface treatment composition can comprise less than 1% by weight of the surface treatment composition surfactant, optionally selected from the group of nonionic surfactant, anionic surfactant, cationic surfactant, zwitterionic surfactant, and mixtures thereof; less than 1% by weight of the surface treatment composition emulsifier, for example selected from the group of ethoxylated castor oils, or hydrogenated castor oil. Additional components of the surface treatment composition can include a buffer, a preservative, a soil agglomerating polymer, a suds suppressor, an antimicrobial agents, a perfume, a thickeners, a chelant, and mixtures thereof.

### Cleaning Products

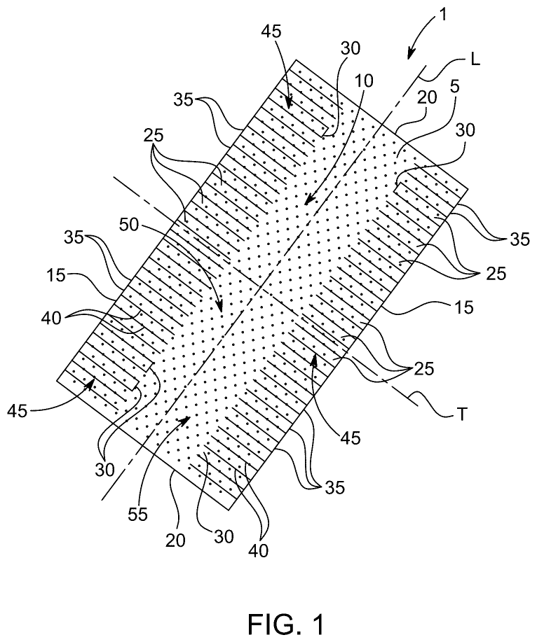

FIG. 1 is a cleaning product 1 that is practical for cleaning surfaces. The cleaning product may be used with the materials constituting the cleaning product 1 being in equilibrium with the temperature, relative humidity, and pressure of the ambient environment. Optionally, a liquid surface treatment composition may first be applied to the surface being cleaned and then lightly dusted or wiped with the cleaning product 1. Optionally, the cleaning product 1 may be a prewetted or prewettable cleaning product 1 that carries a liquid surface treatment composition onboard the cleaning product 1. The liquid surface treatment composition may be carried by or in the interstitial spaces between fibers constituting the cleaning product 1. Optionally, the liquid surface treatment composition may be contained in one or more rupturable capsules or within a porous network framework that contains the liquid surface treatment composition until it is released by applying force prior to use or by forces applied during use of the cleaning product 1.

The cleaning product 1 can have a longitudinal axis L and a transverse axis T orthogonally intersecting the longitudinal axis L. The transverse axis T can intercept the longitudinal axis L at the midpoint of the longitudinal axis L. The cleaning product 1 can have opposing transverse edges 20 that cross the longitudinal axis L and longitudinal edges 15 that are spaced apart from the longitudinal axis L. The longitudinal edges 15 can extend between the transverse edges 20, i.e. from one transverse edge 20 to the other transverse edge 20. The transverse edges 20 can extend between the longitudinal edges 15 and cross the longitudinal axis L. The longitudinal edges 15 can be spaced apart from the longitudinal axis L.

The cleaning product 1 can comprise a first nonwoven 5. With respect to the first nonwoven 5, the term first is used as numeric identifier and does not imply a particular position. The first nonwoven 5 can extend along the longitudinal axis L and extend towards or out to the longitudinal edges 15. The first nonwoven 5 or a portion thereof, such as the first nonwoven central portion 10, which can lie along the longitudinal axis L, or first nonwoven strips 25, which can extend from the first nonwoven central portion 10, can carry an adhesion agent. The adhesion agent can be selected from, or selected from the group of, or selected from the group consisting of oil, wax, adhesive, and combinations thereof. With the cleaning product comprising a first nonwoven 5 having a first nonwoven central portion 10, the longitudinal axis L can lie in the plane of the first nonwoven central portion 10 of the first nonwoven 5.

The cleaning product 1 can have length along the longitudinal axis, that is between the transverse edges 20, from about 0.08 m to about 1 m. The cleaning product 1 can have a width measured orthogonal to the longitudinal axis L, that is between the longitudinal edges 15, from about 6 cm to about 30 cm. The width can be constant or vary as a function of position along the longitudinal axis L. The length along the longitudinal axis L can be greater than the width along the transverse axis T. The transverse edges 20 and longitudinal edges 15 can be straight, substantially straight, generally straight, curved, wavy, zigzag or other continuous collection of points.

The first nonwoven central portion 10 can be along the longitudinal axis L. The first nonwoven central portion 10 can extend continuously or discontinuously along part of or the entirety of the longitudinal axis L. A plurality of first nonwoven strips 25 can extend from the first nonwoven central portion 10. The first nonwoven central portion 10 can have a width measured orthogonal to the longitudinal axis L from about 0.1 mm to about 100 mm, optionally from about 0.5 mm to about 100 mm, optionally from about 1 mm to about 100 mm, optionally from about 2 mm to about 100 mm, optionally from about 20 mm to about 50 mm, optionally from about 20 mm to about 40 mm, optionally any range within the aforesaid ranges. The first nonwoven central portion 10 can be coextensive with one or more bonds on or along or along and spaced apart from the longitudinal axis L joining the first nonwoven 5 to other optional layers constituting the cleaning product 1. The first nonwoven central portion 10 can be part of the structural foundation of the cleaning product 1 that provides the cleaning product 1 with some degree of rigidity so that the cleaning product 1 can be easily handled by the user without the cleaning product 1 uncontrollably or unintentionally flopping and or folding in a manner that is frustrating to the user.

First nonwoven strips 25 can be formed by providing cuts along the longitudinal edges 15 of the first nonwoven 5, the more centrally located portion of the first nonwoven 5 being the first nonwoven central portion 10. The cuts can be straight, substantially straight, generally straight, curved, wavy, zigzag or other continuous collection of points defining the cuts.

First nonwoven strips 25 can comprise first nonwoven fixed ends 30 along the first nonwoven central portion 10 and extend to first nonwoven free ends 35. Together, the first nonwoven fixed ends 30 can define the bounds for the first nonwoven central portion 10. Optionally, the first nonwoven free ends 35 can together define the longitudinal edges 15.

The first nonwoven fixed ends 30 and first nonwoven free ends 35 of the first nonwoven strips 25 can be from about 5 mm to about 200 mm, optionally from about 10 mm to about 200 mm, optionally from about 20 mm to about 100 mm, optionally from about 20 mm to about 60 mm, apart from one another when the first nonwoven strips 25 are in a flattened condition, which is descriptive of the length of the first nonwoven strips 25. The first nonwoven strips 25 can comprise lateral edges 40 extending from the first nonwoven fixed ends 30 to the first nonwoven free ends 35. The lateral edges 40 of the first nonwoven strips 25 can be from about 2 mm to about 40 mm, optionally from about 5 mm to about 20 mm, optionally from about 5 mm to about 15 mm, apart from one another, which is descriptive of the width of the first nonwoven strips 25. The first nonwoven strips 25 can have a ratio of length to width from about 1 to about 20, optionally from about 1 to about 10, optionally from about 2 to about 5.

The cleaning product 1 can further comprise a first plurality of nonfibrous polymeric elements 45 engaged with the first nonwoven 5. The first plurality of nonfibrous polymeric elements 45 can be engaged with the first nonwoven strips 25. The first plurality of nonfibrous polymeric elements 45 can constitutively differ from the first nonwoven 5. The first plurality of nonfibrous polymeric elements 45 can be arranged in a space centered pattern, node centered pattern, randomly, or other ordered or disordered arrangement. Each first nonwoven strip 25 can comprise from about 2 to about 50, optionally from about 5 to about 30, optionally from about 5 to about 20, individual nonfibrous polymeric elements.

The first nonwoven 5 can have a first nonwoven downwardly facing surface 50 and a first nonwoven upwardly facing surface opposite the first nonwoven downwardly facing surface 50. Downwardly and upwardly are used in the context of use of the cleaning product 1, downwardly being oriented towards the surface being cleaned, for example a floor or the edge of a picture frame, and upwardly being oriented away from the surface being cleaned, the cleaning product 1 being considered in an unfluffed state for cleaning products 1 having strips or a flat state for cleaning products 1 without strips. The first nonwoven downwardly facing surface 50 can extend from the longitudinal axis L to the first nonwoven free ends 35. The first nonwoven downwardly facing surface 50 can be the surface of the first nonwoven 5 in the first nonwoven central portion 10 that is oriented towards the surface being cleaned when the cleaning product 1 is being used and extends along the first nonwoven strips 25 from the first nonwoven fixed ends 30 to the first nonwoven free ends 35 with the first nonwoven strips 25 in a flat or untwisted and extended condition. If the first nonwoven strips 25 are fluffed, it is possible or even likely that the first nonwoven downwardly facing surface 50 of some of the first nonwoven strips 25 or parts thereof may be oriented away from the surface being cleaned since the first nonwoven strips 25 may be twisted or curled upon themselves. The cleaning product 1 can exist in a flattened state in which the first nonwoven strips 25 are extended and untwisted and in plane with one another and in plane with the first nonwoven central portion 10. Such an arrangement can minimize the bulk of the cleaning product 1, which may improve the ability to tightly pack multiple cleaning products 1 in a single package.

The cleaning product 1 can further comprise central nonfibrous polymeric elements 55 engaged with the first nonwoven central portion 10. The central nonfibrous polymeric elements 55 can be constitutively the same as the first plurality of nonfibrous polymeric elements 45.

The first plurality of nonfibrous polymeric elements 45 can be the same color as the first nonwoven 5 or contrast in color from the first nonwoven 5. The first plurality of nonfibrous polymeric elements 45 can comprise a colorant, dye, or pigment to impart the desired color to the nonfibrous polymeric elements 45. For example, the first nonwoven 5 can be white and members of the first plurality of nonfibrous polymeric elements 45 can be blue, green, red, or other color that contrasts with the color of the first nonwoven 5. The first plurality of nonfibrous polymeric elements 45 and the first nonwoven 5 can contrast in color as observed by an observer having ordinary visual acuity in unobstructed sunlight at local noontime at a latitude between 40 degrees north and 40 degrees south. The first plurality of nonfibrous polymeric elements 45 can comprise individual nonfibrous polymeric elements having colors that differ from one another or be the same color as one another.

Optionally the cleaning product 1 can further comprise a surface treatment composition comprising a surfactant in contact with or carried by the first nonwoven 5 and or optional second layer and or optional absorbent core. The cleaning composition can be provided in an amount that is from about 500% to about 2500%, optionally from about 500% to about 1000%, optionally from about 600% to 800%, optionally about 700% of the weight of the first nonwoven 5.

The cleaning product 1 can be provided to the user in a condition in which the first nonwoven 5 is prewetted with the surface treatment composition. In use, pressure applied to the cleaning product 1 by the user can express the surface treatment composition from components of the cleaning product 1, for example the first nonwoven 5, optional second layer, and or optional absorbent core, onto the surface being treated or cleaned. The user can then rub or wipe the cleaning product 1 against the surface being treated or cleaned. The surface treatment composition can comprise chemical constituents to help dislodge dust, debris, and other detritus from the surface and the first nonwoven 5 or other materials of the cleaning product 1 can acquire the material disassociated from the surface being treated or cleaned. Optionally, the surface treatment composition can comprise chemical constituents to impart a scent to, increase the shine of, and or disinfect the surface being treated.

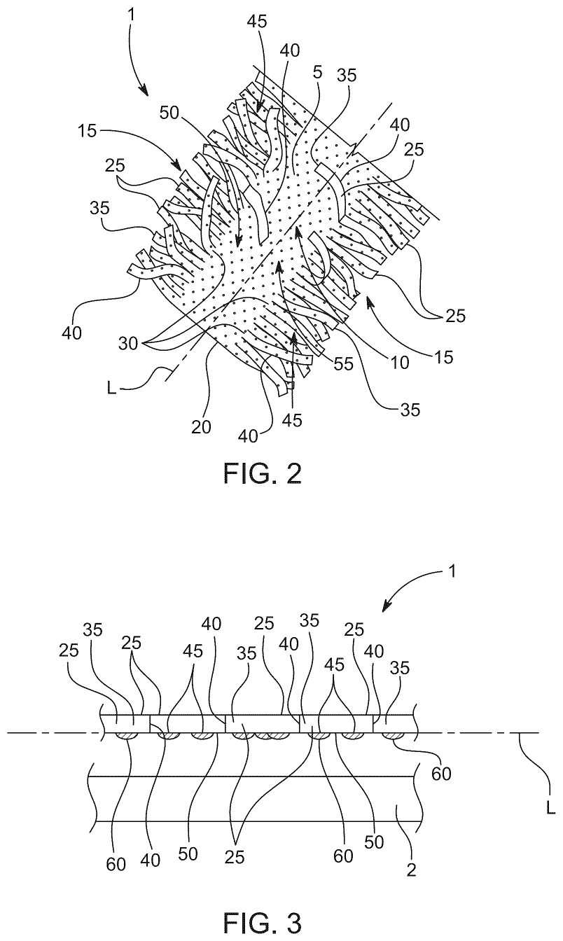

The cleaning product 1 can optionally be fluffed, as shown in FIG. 2, which is a part of a cleaning product 1. The cleaning product 1 can be fluffed as part of the manufacturing process or fluffed by the user of the cleaning product 1. Conceptually in regard to fluffing, the first nonwoven 5 can have a first configuration in which the first nonwoven strips 25 are in plane with one another, i.e. unfluffed, and a second configuration in which a majority of the first nonwoven strips 25 are bent out of plane about the first nonwoven fixed ends 30, i.e. fluffed. Fluffing the cleaning product 1 prior to use can improve the cleaning efficacy of the cleaning product 1 as compared to an unfluffed cleaning product 1. In a fluffed condition, a greater surface area of the first nonwoven strips 25 may contact the surface being cleaned than might occur in an unfluffed condition. Fluffing also can expose the lateral edges 40 of the first nonwoven strips which can provide lightly abrading edges to help dislodge detritus from the surface being cleaned.

The first plurality of nonfibrous polymeric elements 45 can provide for an easy way for users to recognize if their cleaning product 1 is fluffed to the desired degree prior to use. In an unfluffed or lightly fluffed condition, the user can see a number of individual nonfibrous polymeric elements oriented towards the user when the user has the cleaning product 1 oriented such that the first nonwoven central portion 10 is oriented towards the user. With increasing amounts of fluffing, more of the first nonwoven strips 25 can become twisted or flopped over such that the first nonwoven free ends 35 point towards the longitudinal edge 15 opposite to the longitudinal edge 15 that they would partially form if the first nonwoven strips 25 were flattened. When the first nonwoven 5 is unfluffed, the entirety of the first plurality of nonfibrous polymeric elements 45 can be in view of the user or the cleaning product 1. With increasing amounts of fluffing, the twisting and flopping of first nonwoven strips 25 increases and more first nonwoven strips 25 adjacent one another may overlap one another, thereby obscuring from view a substantial fraction of the first plurality of nonfibrous polymeric elements 45. The degree of fluffing can be indicated by or associated with the number of visible nonfibrous polymeric elements of the first plurality of nonfibrous polymeric elements 45 by the user viewing the cleaning product 1. For example, the first plurality of nonfibrous polymeric elements 45 may number 1000 nonfibrous polymeric elements. When the first nonwoven 5 is unfluffed in flattened condition, the user can see all 1000 of the nonfibrous polymeric elements. When the first nonwoven 5 is fluffed, thereby twisting, flopping, and overlapping various first nonwoven strips 25, the number of visible nonfibrous polymeric elements may tend to decrease. For example, in a nonlimiting fashion, in a fluffed conditions, it is possible that only 750, or fewer or more depending on the degree of fluffing and construction of the cleaning product 1, of the nonfibrous polymeric elements remain visible to the user. The fewer visible nonfibrous polymeric elements, the greater the degree of fluffing that might be inferred.

In a fluffed condition, it is possible that the lateral edges 40 of some of the first nonwoven strips 25 are engaged with one or more nonfibrous polymeric elements of an adjacent or neighboring first nonwoven strip 25, neighboring meant to include first nonwoven strips 25 that are adjacent to one another as well as those that may be two or even three first nonwoven strips 25 away or even first nonwoven strips 25 that have flopped over from one side of the longitudinal axis L to the other side of the longitudinal axis L. The lateral edges 40 of the first nonwoven strips 25 may be mechanically engaged with one or more nonfibrous polymeric elements of a neighboring first nonwoven strip 25 for example by sliding friction, abutment, or other arrangement in which two objects may physically engage with one another under compressive forces. Individual nonfibrous polymeric elements of the first plurality of nonfibrous polymeric elements 45 can project outwardly away from the first nonwoven downwardly facing surface 50 of the first nonwoven strips 25, which can increase the likelihood that some of the first nonwoven strips 25 that are near one another mechanically engage with surrounding first nonwoven strips 25 when fluffed and used.

A profile view of a first nonwoven 5 forming part of a cleaning product 1 is shown in FIG. 3, the view being that such that the first nonwoven free ends 35 are oriented towards the viewer. For clarity, an object 2 to be cleaned is also illustrated. The first plurality of nonfibrous polymeric elements 45 can project outwardly away from the first nonwoven downwardly facing surface 50. The first nonwoven 5 or the combination of the first nonwoven 5, first nonwoven strips 25, and protruding nonfibrous polymeric elements can be more abrasive than the first nonwoven 5 alone, in absence of first nonwoven strips 25, and the first nonwoven 5 and first nonwoven strips 25 alone. The outwardly projecting first plurality of nonfibrous polymeric elements 45 provides for a rougher surface profile than can be provided in absence of such projecting elements.

At least some of the members of the first plurality of nonfibrous polymeric elements 45 can comprise a substantially flat surface 60 substantially parallel to the first nonwoven downwardly facing surface 50 of said first nonwoven strips 25. When the ink constituting the first plurality of nonfibrous polymeric elements 45 is puffed, the peaks of the nonfibrous elements 45 may have some jagged contours that may more abrasive than desired, particularly if any of the expandable encapsulated gas ruptures during puffing of the ink. To reduce or control the resulting abrasiveness, these jagged peaks can be slightly smoothed after the ink dries by passing or contacting the printed first nonwoven 5 over one or more rollers or rounded surfaces or passing the printed first nonwoven 5 between the nip of a pair of rollers or rounded surfaces.

The first plurality of nonfibrous polymeric elements 45 can have a freestanding cumulative volume beyond the first nonwoven downwardly facing surface 50 of the first nonwoven strips 25 that is less than 0.025 mm³/mm², optionally less than 0.02 mm³/mm², optionally less than 0.015 mm³/mm², optionally less than 0.013 mm³/mm², optionally from about 0.005 mm³/mm² to about 0.025 mm³/mm², optionally from about 0.01 mm³/mm² to about 0.025 mm³/mm², optionally from about 0.01 mm³/mm² to about 0.02 mm³/mm². The freestanding cumulative volume is the cumulative volume of the first plurality of nonfibrous polymeric elements 45 projecting beyond the first nonwoven downwardly facing surface 50 of the first nonwoven strips 25 with no external loading of the first plurality of nonfibrous polymeric elements 45, the first plurality of nonfibrous polymeric elements 45 being an aggregate of nonfibrous polymeric elements engaged with the first nonwoven strips 25.

Each of the first nonwoven strips 25 can have a strip mass. Members of the first plurality of nonfibrous polymeric elements 45 on an individual first nonwoven strip 25 have a cumulative nonfibrous polymeric element mass. The cumulative nonfibrous polymeric element mass can be from about 1% to about 60% of the strip mass, optionally from about 5% to about 30%, optionally from about 8% to about 15%. Such an arrangement can be practical so that the mass of nonfibrous polymeric elements on a given first nonwoven strip 25 is not so much that the bending response of the combination of the strip and nonfibrous polymeric elements is dominated by the mass of the first plurality of nonfibrous polymeric elements 45 as compared to the first nonwoven strip 25 per se.

The cleaning product can comprise from about 0.5 g/m² to about 30 g/m², optionally from about 0.5 g/m² to about 20 g/m², optionally from about 1 g/m² to about 10 g/m² of said first plurality of nonfibrous polymeric elements 45. At that level of application, an adequate degree of roughness can provided to the first nonwoven strips 25 to improve the efficacy of the first nonwoven strips 25 for dislodging dust from a surface.

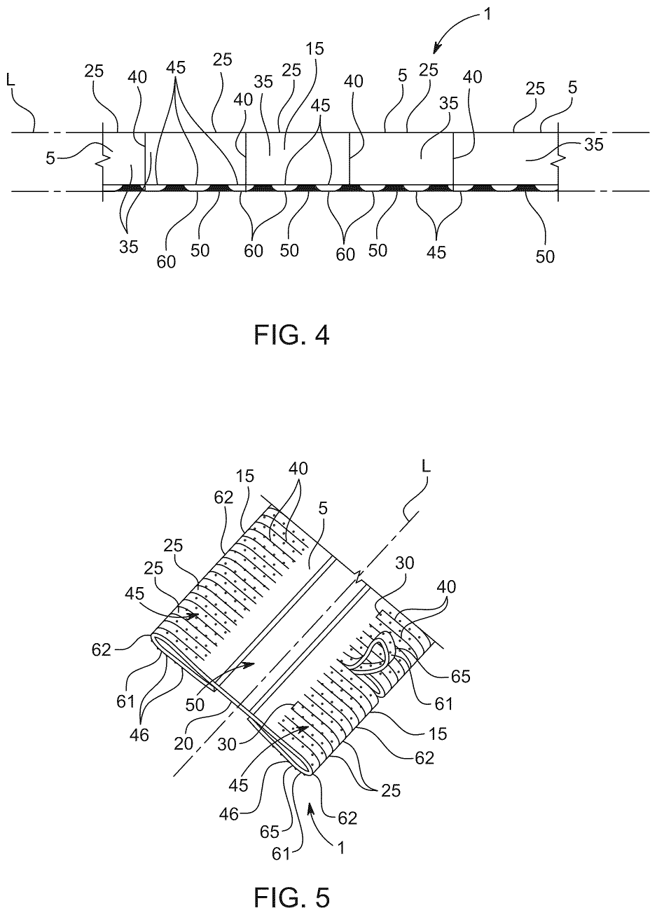

The contribution of the first plurality of nonfibrous polymeric elements 45 to the bulkiness of the cleaning product 1 can be characterized by the pattern created volume. The pattern created volume is the void volume between the surface of the nonwoven web and a plane P that is in contact with the top surface of the first plurality of nonfibrous polymeric elements 45 at an applied pressure of 2 kPa, conceptually illustrated in FIG. 4. The pattern created volume is calculated per unit of surface area of the first nonwoven downwardly facing surface 50 and is represented in FIG. 4 by the shaded region. Members of the first plurality of nonfibrous polymeric elements 45 can be sized and dimensioned such that the pattern created volume can be from about 0.2 mm to about 1 mm, optionally from about 0.2 mm to about 0.8 mm, optionally from about 0.3 to about 0.8 mm, optionally from about 0.4 to about 0.6 mm. Without being bound by theory, a pattern created volume greater than 1 mm may be overly abrasive for some surfaces or may limit the availability of available surface area of the first nonwoven 5 for acquiring dust, debris, and other detritus.

The lateral edges 40 of the first nonwoven strips 25 can intercept one or more members of the first plurality of nonfibrous polymeric elements 45. The lateral edges 40 can be formed by cutting the longitudinal edges 15 of the first nonwoven 5. Where the cuts to form the first nonwoven strips 25 intercept a nonfibrous polymeric element, a sharp edge of the nonfibrous polymeric element can be formed. These sharp edges can provide enhanced abrasiveness along the lateral edges 40 of the first nonwoven strips 25.

The first nonwoven 5 can be folded upon itself along one or more fold lines 62 parallel to the longitudinal axis L, by way of nonlimiting example as shown in FIG. 5. The first nonwoven 5 can be gate folded upon itself. Folding the first nonwoven 5 upon itself can effectively bulk up the first nonwoven 5. Folding can also provide for forming first nonwoven strips 25 that are loops 61 of material. During use, the loops 61 can open up, thereby providing for more surface area available to dislodge and acquire detritus from the surface being cleaned. Folding the first nonwoven 5 can also be used to creatively transform what was formerly a flat nonwoven having nonfibrous polymeric elements on only one side into a structure that has nonfibrous polymeric elements on both sides of the structure without actually having to print on both sides of a material, which can be technically challenging. The first nonwoven strips 25 can have a first nonwoven upwardly facing surface 65 opposite the first nonwoven downwardly facing surface 50. Additional nonfibrous polymeric elements 46 can be engaged with the first nonwoven upwardly facing surface 65. The additional nonfibrous polymeric elements 46 can be constitutively the same as the individual nonfibrous polymer elements forming the first plurality of nonfibrous polymeric elements 45.

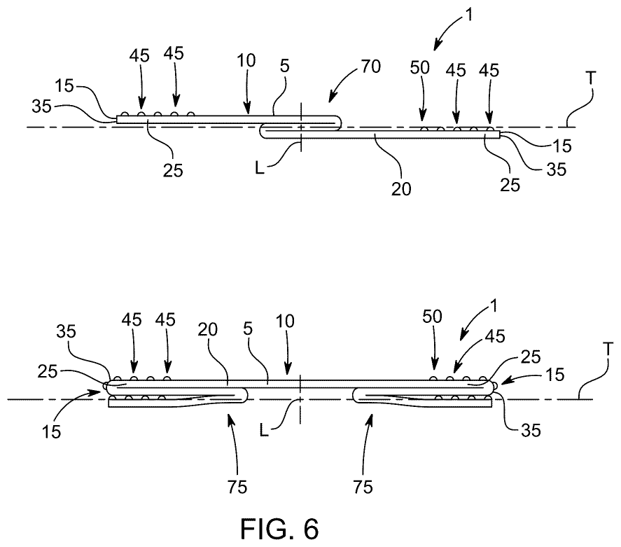

Optionally, the first nonwoven 5 can be provided with a Z fold 70 encompassing the longitudinal axis L to provide bulk to the cleaning product 1 along the longitudinal axis L or form a sleeve within the cleaning product 1 within which a handle may be engaged (FIG. 6). Optionally, an open gate fold 75 can be used to provide for layers of strips along the longitudinal edges 15 of the cleaning product 1.

Another way to provide bulk to the cleaning product 1 is to provide one or more additional layers of material. Additional layers of material can be provided by folding the first nonwoven 5 in a manner in which the folded material ends up crossing back over the longitudinal axis L or by joining a separate additional layer of material to the first nonwoven 5.

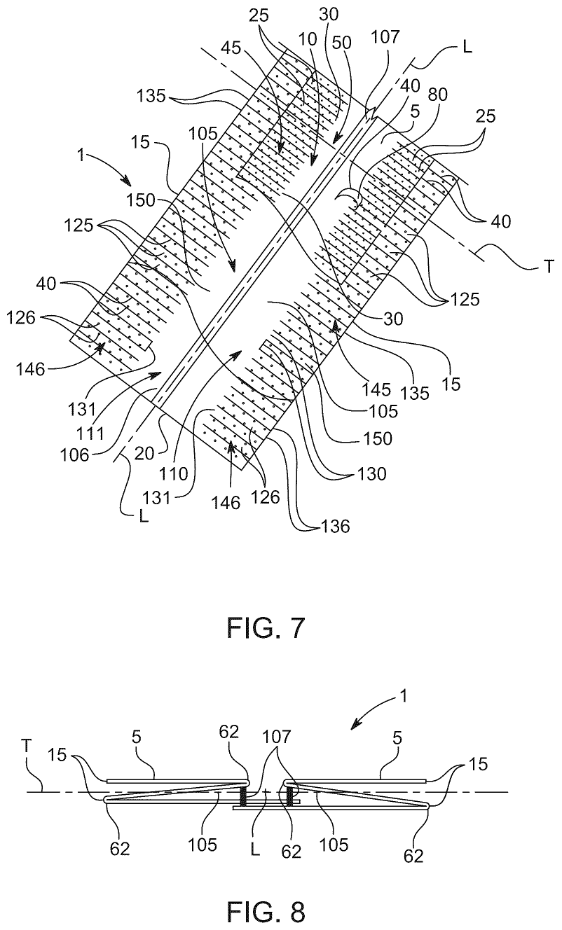

The cleaning product 1 can further comprise a second layer 105, and optionally a third layer 106, joined to the first nonwoven central portion 10, by way of nonlimiting example as shown in FIG. 7. The terms second and third are used as numeric identifiers and does not imply a particular position. The second layer 105, and optional third layer 106, can be a nonwoven. As described herein, the second layer 105 can be a nonwoven and also be referred to or claimed as the second nonwoven using the same reference number. Likewise the third layer 106 can be a nonwoven and also be referred to or claimed as the third nonwoven using the same reference number. The second layer 105 can be joined to the first nonwoven central portion 10 by a bond 107 or bonds 107, joined contemplated to be directly joined or indirectly joined. For example, the second layer 105 can be joined directly to the first nonwoven central portion 10 such that the second layer 105 is in contact with the first nonwoven central portion 10. Optionally, the second layer 105 can be joined indirectly to the first nonwoven central portion 10 through one or more intermediate layers between the second layer 105 and the first nonwoven 5. The bond 107 or bonds 107 can extend along and or be parallel to the longitudinal axis L. Optionally, the bond 107 can be coincident or partially coincident with the longitudinal axis L. The bond 107 or bonds 107 can be coincident with at least some individual central nonfibrous polymeric elements 55. Such an arrangement can be practical in that careful control of the web from which the first nonwoven 5 is formed need not be maintained during application of the various nonfibrous polymeric elements and further converting of the nonwovens. The manufacturer does not have to spend effort to make sure that the bond 107 or bonds 107 are not coincident with one or more nonfibrous polymeric elements. Rather, some of the nonfibrous polymeric elements can be in or coincident with the bond 107 or bonds 107.

The first nonwoven downwardly facing surface 50 can be oriented away from the second layer 105 and the first plurality of nonfibrous polymeric elements 45 can be engaged with the first nonwoven downwardly facing surface 50. The first nonwoven 5 can have a first nonwoven upwardly facing surface 80 opposite the first nonwoven downwardly facing surface 50. The first nonwoven upwardly facing surface 80 can be oriented towards the second layer 105. There can be more nonfibrous polymeric elements engaged with first nonwoven downwardly facing surface 50 than the first nonwoven upwardly facing surface 80.

The second layer 105 can comprise a second layer central portion 110 along the longitudinal axis L. A plurality of second layer strips 125 extending from the second layer central portion 110. The second layer strips 125 can comprise second layer fixed ends 130 along the second layer central portion 110 and extend to second layer free ends 135. Like the first nonwoven strips 25, the second layer strips 125 can function to dislodge and gather detritus from the surface being cleaned. The second layer fixed ends 130 and second layer free ends 135 of the second layer strips 125 can be from about 5 mm to about 200 mm, optionally from about 10 mm to about 200 mm, optionally from about 20 mm to about 100 mm, optionally from about 20 mm to about 60 mm, apart from one another when the second layer strips 125 are in a flattened condition, which is descriptive of the length of the second layer strips 125. The second layer strips 125 can comprise lateral edges 40 extending from the second layer fixed ends 130 to the second layer free ends 135. The lateral edges 40 of the second layer strips 125 can be from about 2 mm to about 40 mm, optionally from about 5 mm to about 20 mm, optionally from about 5 mm to about 15 mm, apart from one another, which is descriptive of the width of the second layer strips 125. The second layer strips 125 can have a ratio of length to width from about 1 to about 20, optionally from about 1 to about 10, optionally from about 2 to about 5.

The cleaning product 1 can further comprise a second plurality of nonfibrous polymeric elements 145 that constitutively differ from the second layer 105 and are engaged with the second layer strips 125. Like the first plurality of nonfibrous polymeric elements 45 discussed above, the second plurality of nonfibrous polymeric elements 145 can help the user determine that the cleaning product 1 is fluffed to the desired degree.

The second plurality of nonfibrous polymeric elements 145 can be the same color as the second layer 105 or contrast in color from the second layer 105. The second plurality of nonfibrous polymeric elements 145 can comprise a colorant, dye, or pigment to impart the desired color to members of the second plurality of nonfibrous polymeric elements 145. For example, the second layer 105 can be white and the second plurality of nonfibrous polymeric elements 145 can be blue, green, red, or other color that contrasts with the color of the second layer 105. The second plurality of nonfibrous polymeric elements 145 and the second layer 105 can contrast in color as observed by an observer having ordinary visual acuity in unobstructed sunlight at local noontime at a latitude between 40 degrees north and 40 degrees south. The second plurality of nonfibrous polymeric elements 145 can comprise individual nonfibrous polymeric elements having colors that differ from one another or be the same color as one another. Individual nonfibrous polymeric elements of the second plurality of nonfibrous polymeric elements 145 can project outwardly away from the second layer downwardly facing surface 150 of the second layer strips 125, which can increase the likelihood that some of the second layer strips 125 or lateral edges 40 thereof catch on some of the first nonwoven strips 25 or lateral edges 40 thereof and vice versa.

The cleaning product 1 can further comprise a third layer 106. The third layer 106 can be structured as described above with respect to the first nonwoven 5 or second layer 105. A third plurality of nonfibrous polymeric elements 146, the third plurality of nonfibrous polymeric elements 146 being as described above with respect to the first plurality of nonfibrous polymeric elements 45 and or second plurality of nonfibrous polymeric elements 145. The third layer 106 an comprise a third layer central portion 111, third layer strips 126 extending from the third layer central portion 111 from third layer fixed ends 131 to third layer free ends 136. The third layer strips 126 can be dimensioned as described above with respect to the first nonwoven strips 25 and the second layer strips 125.

A cleaning product 1 that includes a second layer 105 having second layer strips 125 can optionally be fluffed. That is, the second layer 105 can have a first configuration in which the second layer strips 125 are in plane with one another, i.e. unfluffed, and a second configuration in which a majority of the second layer strips 125 are bent out of plane about the second layer fixed ends 130, i.e. fluffed. Fluffing can improve the cleaning efficacy of the cleaning product 1 as compared to an unfluffed cleaning product since fluffing can result in more contact with the surface being cleaned and expose the lateral edges 40 of the second layer strips 125 to the surface being cleaned and expose the various nonfibrous polymeric elements of various layers to the surface being cleaned. In the second configuration, fewer members of the first plurality of nonfibrous polymeric elements 45 can oriented away from the second layer 105 than in the first configuration

The second layer 105 can have a second layer downwardly facing surface 150 oriented towards the first nonwoven 5 in the second layer central portion 110 and extend along the second layer strips 125 from the second layer fixed ends 130 to the second layer free ends 135. In use the second layer downwardly facing surface 150 in the second layer central portion 110 can be oriented towards, that is direction of, the surface being cleaned. The second plurality of nonfibrous polymeric elements 145 can be engaged with the second layer downwardly facing surface 150. The second plurality of nonfibrous polymeric elements 145 can be oriented towards the first nonwoven 5. Optionally, there can be more nonfibrous polymeric elements on the second layer downwardly facing surface 150 than on the opposing upwardly facing surface thereof, the second layer upwardly facing surface opposing the second layer downwardly facing surface 150. The second layer upwardly facing surface can be free of nonfibrous polymeric elements. Optionally, the second layer upwardly facing surface can comprise fewer nonfibrous polymeric elements than the second layer downwardly facing surface.

The second layer 105 can be laterally more extensive away from the longitudinal axis L than the first nonwoven 5. That is, the second layer 105 can extend further away from the longitudinal axis L than the first nonwoven 5. If optional second layer strips 125 are provided, the second layer strips 125 can extend further away from the longitudinal axis L than the first nonwoven strips 25 extend away from the longitudinal axis L. Such an arrangement can expose more of the second layer 5 to the surface being cleaned than if the first nonwoven 5 and second layer 105 are coextensive with one another and provide the cleaning product 1 with a more variable surface profile to the surface being cleaned.

The second layer 105 can extend from the first nonwoven 5 at a fold line 62 between the first nonwoven 5 and the second layer 105 (FIG. 8). Structures having the second layer 105 extend from the first nonwoven 5 at a fold line 62 can reduce the number of webs that need to be handled when fabricating the cleaning product 1. Moreover, complex multilayer structures for the cleaning product 1 can even be fabricated from a single continuous web that is folded and bonded and then cut across the longitudinal axis L, for example as described herein. The second layer 105 can extend from the first nonwoven 5 at a fold line 62 that is part of a half fold, double parallel fold, a Z fold, a roll fold, a gate fold, a double closed gate fold, an open gate fold, a concertina fold, a right angle French fold, a Z fold plus half, a tri fold plus half, double parallel fold plus half, and other fold structures that have a fold line 62 or one or more fold lines 62 substantially parallel to the longitudinal axis L.

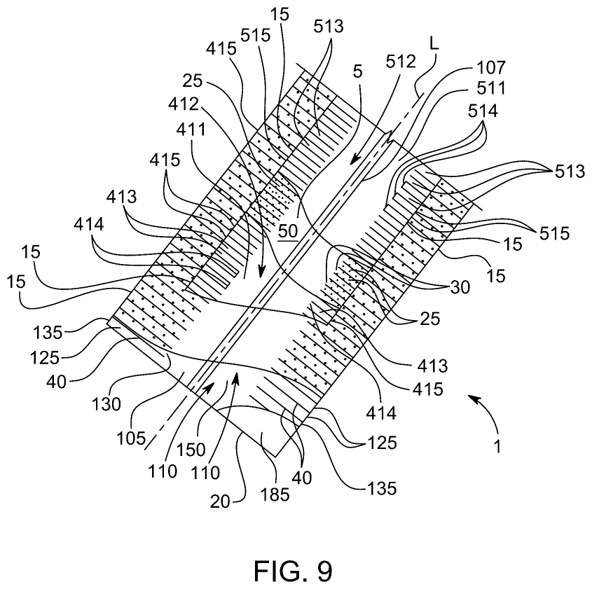

The cleaning product 1 can further comprise an intermediate layer 411 or one or more intermediate layers 411 (FIG. 9). The intermediate layer 411 can be a nonwoven material. An intermediate layer 411 can be positioned between the first nonwoven 5 and the second layer 105. The intermediate layer 411 can comprise a intermediate layer central portion 412 along the longitudinal axis L. The intermediate layer 411 can comprise a plurality of intermediate layer strips 413 extending from the intermediate layer central portion 412. The intermediate layer strips 413 can comprise intermediate layer fixed ends 414 along the intermediate layer central portion 412 and extend to intermediate layer free ends 415. The intermediate layer strips 413 can be dimensioned as described above with respect to the first nonwoven strips 25 and the second layer strips 125.

The intermediate layer strips 413 can be formed by providing cuts along the longitudinal edges 15 of the intermediate layer 411, the more centrally located portion of the intermediate layer 411 being the intermediate layer central portion 412. The cuts can be straight, substantially straight, generally straight, curved, wavy, zigzag or other continuous collection of points defining the cuts.

Together, the intermediate layer fixed ends 414 can define the bounds for the intermediate layer central portion 412. Optionally, the intermediate layer free ends 415 can together define the longitudinal edges 15.

The intermediate layer 411 or intermediate layers 411 can be coextensive with the first nonwoven 5. The intermediate layer 411 or intermediate layers 411 can be laterally more extensive away, that is extend further away from, from the longitudinal axis L than the first nonwoven 5. Likewise, the intermediate layer 411 or intermediate layers 411 can be coextensive with the second layer 105. Optionally, the intermediate layer 411 or intermediate layers 411 can be laterally more extensive away, that is extend further away from, from the longitudinal axis L than the second layer 105. An arrangement in which one intermediate layer 411 is laterally more extensive away from the longitudinal axis L than the first nonwoven and another intermediate layer 411 is laterally more extensive away from the longitudinal axis L than the second layer 105 can be practical.

The cleaning product 1 can further comprise an outer layer 511, or one or more outer layers 511. The outer layer 511 can be a nonwoven material. The outer layer 511 can be positioned such that the first nonwoven 5 is between the outer layer 511 and the second layer 15. Likewise, the first nonwoven 5 can be between the outer layer 511 and an intermediate layer 411. The outer layer 511 can comprise an outer layer central portion 512 along the longitudinal axis L. The outer layer 511 can comprise a plurality of outer layer strips 513 extending from the outer layer central portion 512. The outer layer strips 513 can comprise outer layer fixed ends 514 along the outer layer central portion 512 and extend to outer layers free ends 515.

The outer layer strips 513 can be formed by providing cuts along the longitudinal edges 15 of the outer layer 511, the more centrally located portion of the outer layer 511 being the outer layer central portion 512. The cuts can be straight, substantially straight, generally straight, curved, wavy, zigzag or other continuous collection of points defining the cuts. The outer layer strips 513 can be dimensioned as disclosed above with respect to the first nonwoven strips 25 and the second layer strips 125.

Together, the outer layer fixed ends 514 can define the bounds for the outer layer central portion 512. Optionally, the outer layer free ends 515 can together define the longitudinal edges 15.

The intermediate layer central portion 412 and or outer layer central portion 512 can have a width measured orthogonal to the longitudinal axis L from about 0.1 mm to about 100 mm, optionally from about 0.5 mm to about 100 mm, optionally from about 1 mm to about 100 mm, optionally from about 2 mm to about 100 mm, optionally from about 20 mm to about 50 mm, optionally from about 20 mm to about 40 mm, optionally any range within the aforesaid ranges. The intermediate layer central portion 412 and or outer layer central portion 512 can be coextensive with one or more bonds on or along or along and spaced apart from the longitudinal axis L joining the intermediate layer 411 to other layers constituting the cleaning product 1.

The intermediate layer fixed ends 414 and intermediate layer free ends 415 of the intermediate layer strips 413 and or the outer layer fixed ends 514 and outer layer free ends 515 of the outer layer strips 513 can be from about 5 mm to about 200 mm, optionally from about 10 mm to about 200 mm, optionally from about 20 mm to about 100 mm, optionally from about 20 mm to about 60 mm, apart from one another when the strips are in a flattened condition, which is descriptive of the length of the strips. The intermediate layer strips 413 and outer layer strips 513 can comprise lateral edges 40 extending from the fixed ends to the free ends of the respective strips. The lateral edges 40 of the intermediate layer strips 413 and or outer layers strips 513 can be from about 2 mm to about 40 mm, optionally from about 5 mm to about 20 mm, optionally from about 5 mm to about 15 mm, apart from one another, which is descriptive of the width of the strips. The intermediate layer strips 413 and outer layer strips 513 can have a ratio of length to width from about 1 to about 20, optionally from about 1 to about 10, optionally from about 2 to about 5.

The cleaning product 1 can further comprise nonfibrous polymeric elements engaged with the intermediate layer 411 and our outer layer 511. The nonfibrous polymeric elements can be engaged with the intermediate layer central portion 412 and or the intermediate layer strips 413 and or the outer layer central portion 512 and or the outer layer strips 513. Like the first plurality of nonfibrous polymeric elements 45 discussed above, the nonfibrous polymeric elements engaged with the intermediate layer 411 and or outer layer 511 can provide for an indicator of the degree of fluffing of the cleaning product 1, provide for roughness that aids with cleaning a surface, and optionally provide for roughness that helps the intermediate layer strips 413 and or outer layer strips 513 and adjacent layers having strips engage with one another to help maintain the cleaning product 1 in a fluffed condition.

By interposing an intermediate layer 411 next to one or both of first nonwoven 5 having first plurality of nonfibrous polymeric elements 45 engaged thereto and a second layer 105 having a second plurality of plurality of nonfibrous polymeric elements 145, when the cleaning product 1 is fluffed, the respective nonfibrous polymeric elements can help engage the fluffed intermediate layer strips 413 and or lateral edges 40 thereof with one or both of the first nonwoven strips 25 and or second layer strips 125, and or lateral edges 40 thereof, and possibly other intermediate layer strips 413 or lateral edges 40 thereof. This can support maintenance of the fluffed condition of the cleaning product 1 after fluffing, which is thought to be a more effective condition for cleaning than an unfluffed condition.

Likewise, the one or more intermediate layers 411 and outer layer 511 and strips thereof can visually contrast from the first nonwoven 5 and or second layer 105. The visual contrast amongst the various strips can provide for a way for the user to recognize if their cleaning product 1 is adequately fluffed. With increasing amounts of fluffing, there can be an increase in the quantity of intertangled strips of the various layers. Intertangling of the strips reveals various materials that might be hidden from view with the cleaning product 1 is in an unfluffed condition by way of nonlimiting example first nonwoven and or secondary layer 105. The more strips from underlying materials that are visible, the greater the amount of fluffing of the cleaning product 1. If the strips of the underlying materials comprise nonfibrous polymeric elements, then it may be possible for relatively few or no nonfibrous polymeric elements of the first plurality of nonfibrous polymeric elements 45 and or second plurality of nonfibrous polymeric elements 145 to be visible to the user when the cleaning product 1 is unfluffed. As the cleaning product 1 is fluffed, more of the first plurality of nonfibrous polymeric elements 45 and or second plurality of nonfibrous polymeric elements 145 may be revealed. The user can ascertain whether the quantity of the first plurality of nonfibrous polymeric elements 45 and or second plurality of nonfibrous polymeric elements 145 as a function of effort applied to fluff the cleaning product. Once the aforesaid quantity in view is becomes roughly constant with additional fluffing effort, the cleaning product 1 is adequately fluffed. Variation in the revelation of the various nonfibrous polymeric elements can be in an indicator of fluffing. When number of the various nonfibrous polymeric elements becomes small, the cleaning product 1 is fluffed. Optionally, the cleaning product 1 can comprise a backsheet 185, with the second nonwoven 105 being between the first nonwoven 5 and the backsheet 185.

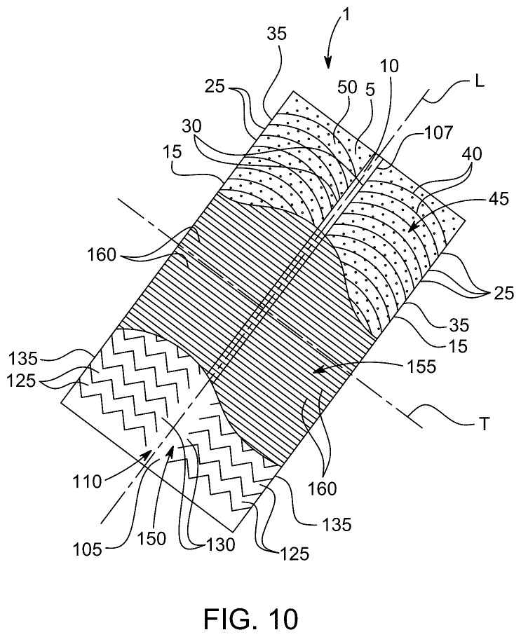

The cleaning product 1 can comprise a tow fibers layer 155 positioned between the first nonwoven 5 and the second layer 105 (FIG. 10). A tow fibers layer 155 can be practical for acquiring fine dust and debris from the surface being cleaned. The constituent tow fibers 160 of the tow fibers layer 155 can extend across the longitudinal axis L. The first nonwoven 5 can be joined to the second layer 105 by a bond 107 that includes the tow fibers layer 155. The bond 107 can extend along part, parts, or all of the nonwoven central portion 10. The first nonwoven central portion 10 can be coextensive with the bond 107. For example the bond 107 can form a spine from which the strips of one or more layers extend. Optionally, the constituent tow fibers 160 can be substantially orthogonal or orthogonal to the longitudinal axis L. The tow fibers layer 155 can extend between the longitudinal edges 15 of the cleaning product 1. The tow fibers layer 155 can be inboard of the longitudinal edges 15 of the cleaning product 1 to protect the tow fibers layer 155 during manufacturing, packing, and storing prior to use.

The cleaning product 1 comprising a tow fibers layer 155 can be fluffed to transition the first nonwoven 5 from a first configuration in which the first nonwoven strips 25 are in plane or generally in plane with one another to a second configuration in which a majority of the first nonwoven strips 25 are bent out of plane about the first nonwoven fixed ends 30. In the second configuration, at least some of the first plurality of nonfibrous polymeric elements 45 are engaged with the tow fibers layer 155. The coefficient of friction of individual nonfibrous polymeric elements may contrast with that of the first nonwoven 5 and some of the constituent tow fibers 160 may catch upon, contact, or otherwise mechanically engage with individual nonfibrous polymeric elements of the plurality of nonfibrous polymeric elements 45. Individual nonfibrous polymeric elements of the plurality of nonfibrous polymeric elements 45 can project outwardly away from the first nonwoven downwardly facing surface 50 of the first nonwoven strips 25, which can increase the likelihood that some constituent tow fibers can catch on or contact or otherwise mechanically engage one or more individual nonfibrous polymeric elements. Engagement amongst the constituent tow fibers 160 and the nonfibrous polymeric elements can help to maintain the cleaning product 1 in a fluffed state after initial fluffing by the user or the manufacturer and possibly during use. Moreover, the nonfibrous polymeric elements can provide some light abrasiveness to the first nonwoven strips 25 which can help dislodge detritus from the surface being cleaned.

Cleaning products 1 are commonly sold in a package containing multiple cleaning products 1, for example more than ten cleaning products 1. Sometimes multiple cleaning products 1 are packed tightly or stuffed into a package. The package can be a paperboard or cardboard carton. The package can be plastic or pulp-based tub or tray. The package can be a polymeric film.

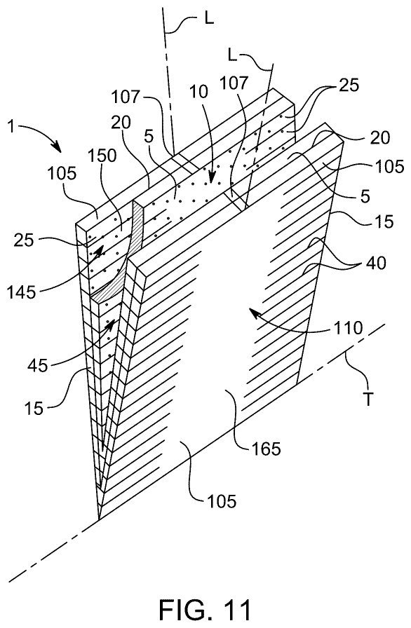

To improve the ability for the cleaning products 1 to be packed tightly in a package, it can be practical to fold each cleaning product 1 in a manner such that the first plurality of nonfibrous polymeric elements 45 is interior to the fold. For example, each cleaning product 1 can comprise a transverse axis T orthogonal to the longitudinal axis L (FIG. 11). The cleaning product 1 can be folded about the transverse axis T such that portions of the first nonwoven 5 on opposite sides of the transverse axis T are interior to the fold, i.e. within the vertex of the fold, or even in face to face relationship with one another. Optionally, when a second layer 105 is part of the cleaning product and is folded about the transverse axis T, portions of the first nonwoven 5 on opposite sides of the transverse axis T can be interior of the second layer 105. That is, the first nonwoven 5 can be in or within the vertex of the fold of the second layer 105, i.e. the first nonwoven 5 can be interior to the fold relative to the second layer 105. In these arrangements, the first plurality of nonfibrous polymeric elements 45 will not or are unlikely to contact the edges of the package as the cleaning products 1 are placed into the package. This can be beneficial because the first plurality of nonfibrous polymeric elements 45 may have coefficient of friction that is greater than that of the first nonwoven 5 per se. If the cleaning product 1 is not folded, it is possible that the first plurality of nonfibrous polymeric elements 45 may be a source for undesirable sliding resistance to the cleaning products 1 fitting into the package. If the cleaning products 1 catch on the edge of the package, the sidewall of the package may undesirably collapse, buckle, or otherwise be uncontrollably disturbed making it difficult to competently close the package. Given that, folding the cleaning product 1 such that the first plurality of nonfibrous polymeric elements 45 are interior to the fold can make packaging the cleaning products 1 easier. If the cleaning product 1 comprises a second layer 105, the second layer upwardly facing surface 165, which is opposite the second layer downwardly facing surface 150, can be oriented towards the exterior of the fold.

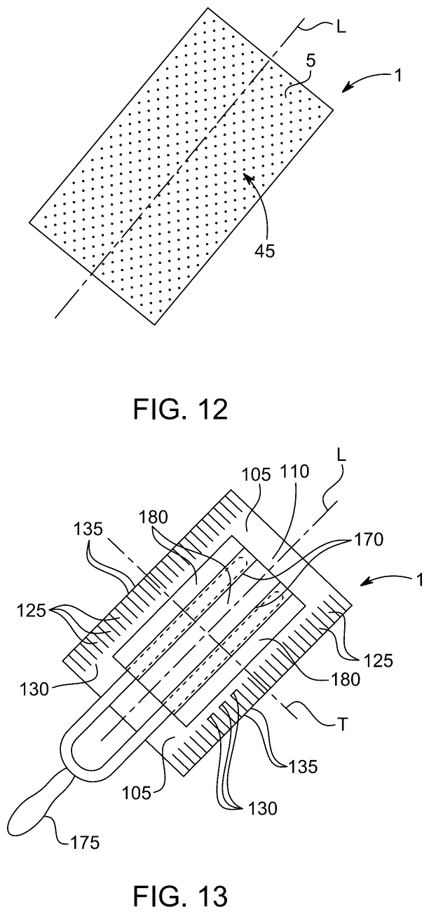

The cleaning product 1 can comprise a first nonwoven 5, a first plurality of nonfibrous polymeric elements 45 that constitutively differ from the first nonwoven 5, wherein the first plurality of nonfibrous polymeric elements 45 are engaged with the first nonwoven 5 and project outwardly away from the first nonwoven 5 (FIG. 12). Members of the first plurality of nonfibrous polymeric elements 45 can be sized and dimensioned to provide a pattern created volume from about 0.2 mm to about 1 mm, optionally from about 0.2 mm to about 0.8 mm, optionally from about 0.3 mm to about 0.8 mm, optionally from about 0.4 mm to about 0.6 mm. Without being bound by theory, a pattern created volume greater than 1 mm may be overly abrasive for some surfaces or may limit the availability of available surface area of the first nonwoven 5 for acquiring dust, debris, and other detritus.

The first nonwoven 5 can carry an adhesion agent to help the first nonwoven 5 acquire and retain dust, debris, and other detritus. The adhesion agent can be selected from, selected from the group of, or selected from the group consisting of oil, wax, adhesive, and combinations thereof. Optionally, the adhesion agent can be selected from, or selected from the group of, or selected from the group consisting of oil, wax, adhesive, and combinations thereof. The adhesion agent can be mineral oil.

The cleaning product 1 can comprise a mechanism for attaching the cleaning product to a handle or mophead. For example, the cleaning product 1 can comprise one or more sleeves 170 into which one or more tines of a handle 175 can be fitted (FIG. 13). The sleeves 170 can be an unbonded portion of two layers joined together, optionally joined together in a facing relationship. For example, the sleeves 170 can be an unbonded portion between a sleeve layer 180 and the second layer 105 that are joined to one another in a facing relationship.

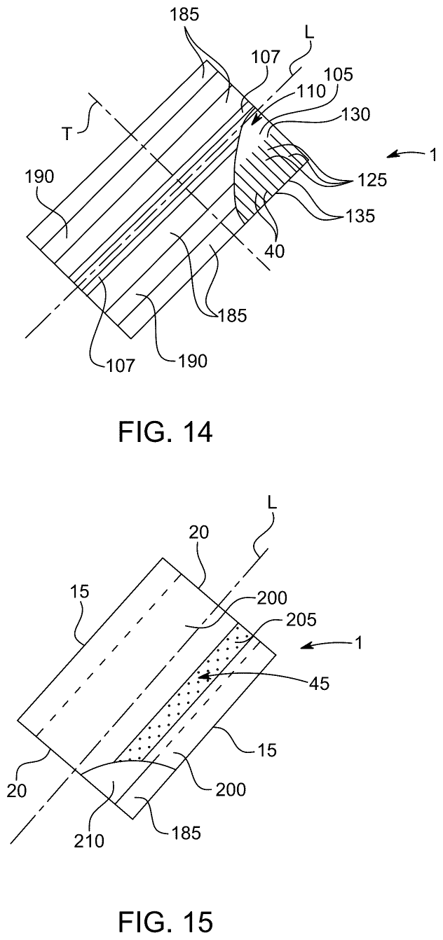

Optionally the cleaning product 1 can comprise a backsheet 185 opposite the first nonwoven 5 (FIG. 14). The backsheet can be a nonwoven or a film. The backsheet 185 can comprise one or more attachment strips 190. The attachment strips 190 can be, way of nonlimiting example, one of hooks or loops material, one of a mushroom shaped knobs or complementarily contoured pillars, or the like. The attachment strips 190 can be an engagement material complementary to the attachment structure on the handle 175 or mophead. For example, the attachment strips 190 can be a loop material attachable to a hook material or a mushroom shaped knobbed material attachable to complementarily contoured pillars. The attachment strips 190 can be a structure that can be repetitively attached to and detached from a handle 175 or mophead.

The cleaning product 1 can comprise a liquid pervious floor sheet 200 having a floor sheet area in a plane defined by the transverse edges 20 and the longitudinal edges 15 (FIG. 15). The cleaning product 1 can further comprise a nonwoven substrate 205 joined to the liquid pervious floor sheet 200. A first plurality of nonfibrous polymeric elements 45 that constitutively differ from the nonwoven substrate 205 can be engaged with the nonwoven substrate 205. The nonwoven substrate 205 can cover from about 2% to about 40% of the floor sheet area. In this arrangement, the nonwoven substrate 205 can be a strip or region of material that that is more abrasive than the floor sheet 200. It can be practical to have a majority of the cleaning product 1 downwardly facing surface, that is the surface of the cleaning product 1 contacting the surface being cleaned, be the liquid pervious floor sheet 200 and at least some of the remainder of the cleaning product 1 downwardly facing surface can be the nonwoven substrate 205. The nonwoven substrate 205 can optionally extend from one transverse edge 20 to the other transverse edge 20. Such a construction can be practical for high speed manufacturing of the cleaning product 1, for example by making the machine direction for converting be in a direction on or along the longitudinal axis L and cutting the nonwoven substrate 205 and other components of the cleaning product from continuous webs of parent materials and cutting individual cleaning products 1 from a continuous web of cleaning products. At least a portion of the floor sheet 200 can be positioned between the nonwoven substrate 205 and the backsheet 185.

The floor sheet 200 can be an apertured nonwoven. For example, the apertured nonwoven can be. The floor sheet may comprise a discrete apertured nonwoven having a basis weight of about 20 to about 80 g/m² and particularly about 28 to 60 g/m². The floor sheet may be hydrophobic and made of synthetic fibers. A suitable floor sheet is a 60 g/m² polyethylene/polypropylene discrete apertured spun bond nonwoven available as SOFSPAN from Fitesa of Simpsonville, SC. The floor sheet may have a contact angle of 101 to 180 degrees with water.

The nonwoven substrate 205 can be positioned inboard of the longitudinal edges 15. Optionally the nonwoven substrate 205 can be at least partially coincident with the longitudinal axis L. The nonwoven substrate 205 can be coincident with a longitudinal edge 15. Optionally, the nonwoven substrate 205 can be inboard of the longitudinal axis L and one longitudinal edge 15. Positioning the nonwoven substrate 205 along the longitudinal axis L or well inboard of the longitudinal edges 15 can limit the amount of stress that can be applied to the nonwoven substrate 205 so as not to be overly abrasive to the surface being cleaned. Optionally, if it is desired that highly concentrated stress be applied to the nonwoven substrate 205, the nonwoven substrate 205 can be placed nearer to or at or along a longitudinal edge 15. In some applications, the cleaning product 1 may be wrapped partially around a mophead such that the nonwoven substrate 205 is positioned over a relatively sharp edge or edge having limited surface area, thereby allowing force applied by the user to be concentrated, thereby generating relatively high contact stress between the nonwoven substrate 205 and the surface being cleaned. The user of the mop can tip the mophead on edge and scrub the surface being cleaned with the nonwoven substrate 205 on or near the edge of the mophead for enhance cleaning efficacy.

The cleaning product 1 can further comprise a surface treatment composition. The surface treatment composition can be in contact with the floor sheet 200 and optionally in contact with the nonwoven substrate 205. In use, the surface treatment composition can be expressed from the cleaning product 1 when the user applies pressure to the cleaning product. The user can then wipe the surface being cleaned with the cleaning product and the surface treatment composition can help clean the surface. The cleaning product 1 that is expressed onto the surface being cleaned can be reacquired by the cleaning product 1 after being spent by wiping the wetted surface with the cleaning product 1.

The cleaning product 1 can further comprise an absorbent core 210. The absorbent core 210 can be between the floor sheet 200 and the backsheet 185, with the nonwoven substrate 205 on a side of the floor sheet 200 opposite the absorbent core 210. The absorbent core 210 can provide a storage volume within which the surface treatment composition is in contact with the constituent fibers or material constituting the absorbent core 210 and carry at least some of the surface treatment composition prior to use of the cleaning product 1, and optionally at least some of the spent surface treatment composition after use.

At least a portion of the floor sheet 200 can be between the nonwoven substrate 205 and the absorbent core 210. That configuration can help the user apply greater pressure to the nonwoven substrate 205 than might be applied if the nonwoven substrate 205 is transversely outboard of the absorbent core 210 since the absorbent core 210 can provide backing support to the nonwoven substrate 205. If less applied pressure to the nonwoven substrate is desirable, as might be the case for cleaning delicate surfaces, the nonwoven substrate 205 being at least partially or even entirely transversely outboard of the absorbent core 210, but possibly within the longitudinal edges 15, might be practical.

The cleaning products 1 described herein comprise, as feature in common amongst the cleaning products 1, a nonwoven material and individual nonfibrous polymeric elements engaged with the nonwoven material, the individual nonfibrous polymeric elements being members of the plurality of nonfibrous polymeric elements formed by the aggregation of individual nonfibrous polymeric elements. As described herein, the nonwoven material can be first nonwoven 5, second layer 105, nonwoven substrate 205. The cleaning products 1 can comprise strips of the nonwoven material having individual nonfibrous polymeric elements engaged thereto. The cleaning products 1 can comprise tow fibers 160. The cleaning products 1 can comprise a floor sheet 200 and nonwoven substrate 205 covering a fraction of the floor sheet, individual nonfibrous polymeric elements being engaged with the nonwoven substrate 205. The cleaning products 1 can comprise a surface treatment composition in contact with a nonwoven material constituting part of the cleaning product 1. Different cleaning products 1 may be practical for different uses. For example, cleaning products 1 including strips of nonwoven may be useful for cleaning the surface of a floor, with or without the addition of or inclusion of a surface treatment composition. Cleaning products 1 that include tow fibers 160 may be useful for dusting household surfaces and items. Cleaning products 1 that include a floor sheet and a nonwoven substrate 205 covering a fraction of the floor sheet 200, individual nonfibrous polymeric elements being engaged with the nonwoven substrate 205, may be well suited for cleaning floors, maybe advantageously by including a surface treatment composition in the cleaning product 1 or applying such a composition to the floor and wiping the wetted floor with the cleaning product 1.

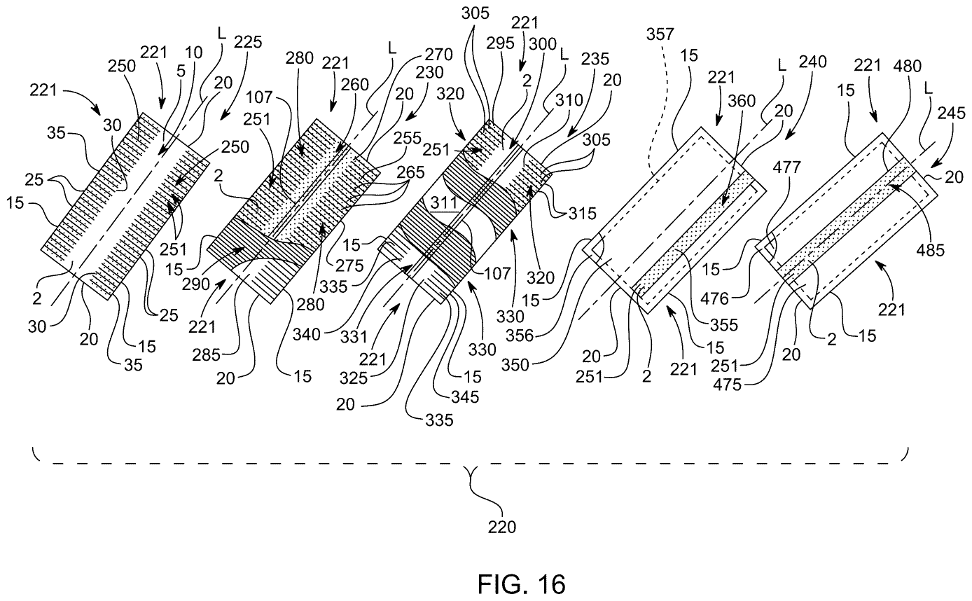

From a user's perspective, it can be practical to provide the cleaning products 1 in an array of cleaning products 220 (FIG. 16). The array of cleaning products 220 can be maintained by the user in his or her household, for example in a closet or on a shelf or in a cabinet or in a pantry, enabling the user to select the right cleaning product 1 for the cleaning job being undertaken by the user. Likewise, the array of cleaning products 220 can be maintained by a retailer that provides such cleaning products 1 to users and the ability for users to select the right cleaning product from the retailer's offering of an array of cleaning products 220. The common feature across the array of cleaning products 220 is the nonfibrous polymeric elements, which for each cleaning product 1, can provide for enhanced cleaning of the surface being cleaned.

The array of cleaning products 220 can comprise at least two members, optionally at least three members, optionally at least four members, optionally at least five members, selected from, selected from the group of, or selected from the group consisting of a first cleaning product 225, a second cleaning product 230, a third cleaning product 235, a fourth cleaning product 240, and a fifth cleaning product 245. Each member can have a longitudinal axis L between opposing transverse edges 20 that cross the longitudinal axis L and longitudinal edges 15 spaced apart from the longitudinal axis L and extending between the transverse edges 20.

Each member 221 of the array of cleaning products 220 can comprise a nonwoven 2. Nonfibrous polymeric elements 251 that constitutively differ from the nonwoven 2 can be engaged with the nonwoven 2. Each member 221 of the array of cleaning products 220 can differ in construction from the other members of the array of cleaning products 220. That is, the members 221 of the array of cleaning products 220 are not products that are identical to one another. The members 221 of the array of cleaning products 220 can differ in construction from other members of the array of cleaning products 220 in a manner such as whether the product includes a surface treatment composition or not, whether the product includes tow fibers or not, whether the product includes an absorbent core or not, whether the product includes a floor sheet or not, whether the product includes strips or not, or other differences in the functional design of the members 221.

The first cleaning product 225, and parts thereof, is described previously with respect to the cleaning product 1 and FIGS. 1 to 9 and 14. Since the cleaning products 1 disclosed herein have various features in common with one another, with respect to this discussion of the array of cleaning products 220, some of the element names and reference numbers differ in some cases from those used previously so that the individual cleaning products 1 constituting the array of cleaning products 220, which have some features in common with one another and some features that differ from one another, can be conveniently described in the context of the array of cleaning products 220.

The first cleaning product 225 can comprise a first nonwoven 5 comprising first nonwoven central portion 10 along the longitudinal axis L. A plurality of first nonwoven strips 25 can extend from the first nonwoven central portion 10. The first nonwoven strips can comprise first nonwoven fixed ends 30 along the first nonwoven central portion 10 and extend to first nonwoven free ends 35. The first cleaning product 225 can further comprise a plurality of first cleaning product nonfibrous polymeric elements 250 that constitutively differ from the first nonwoven 5 and are engaged with the first nonwoven strips 25.

The second cleaning product 230, and parts thereof, is described previously with respect to the cleaning product 1 and FIGS. 10, 11, and 13. The second cleaning product 230 can comprise a second cleaning product upper nonwoven 255. The second cleaning product upper nonwoven 255 can comprise a second cleaning product upper nonwoven central portion 260 along the longitudinal axis L. A plurality of second cleaning product upper nonwoven strips 265 can extend from the second cleaning product upper nonwoven central portion 260. The second cleaning product upper nonwoven strips 265 can comprise second cleaning product upper nonwoven fixed ends 270 along the second cleaning product upper nonwoven central portion 260 and extend to second cleaning product upper nonwoven free ends 275. A plurality of second cleaning product nonfibrous polymeric elements 280 that constitutively differ from the second cleaning product upper nonwoven 255 can be engaged with the second cleaning product upper nonwoven strips 265. The second cleaning product 230 can further comprise a second cleaning product lower nonwoven 285 and a second cleaning product tow fiber layer 290 positioned between and joined to the second cleaning product upper nonwoven 255 and the second cleaning product lower nonwoven 285. The constituent fibers of the second cleaning product tow fiber layer 290 can cross the longitudinal axis L. The second cleaning product can optionally comprise an adhesion agent carried by one or more of the second cleaning product upper nonwoven 255, the second cleaning product tow fiber layer 290, and the second cleaning product lower nonwoven 285. The second cleaning product 230, when fluffed, can have one fluffy side that can presented to the surface being cleaned.

The third cleaning product 235, and parts thereof, is described previously with respect to the cleaning product 1 and FIGS. 10, 11, and 13. The third cleaning product 235 can comprise a third cleaning product upper nonwoven 295. The third cleaning product upper nonwoven 295 can comprise a third cleaning product upper nonwoven central portion 300 along the longitudinal axis L. A plurality of third cleaning product upper nonwoven strips 305 can extend from the third cleaning product upper nonwoven central portion 300. The third cleaning product upper nonwoven strips 305 can comprise third cleaning product upper nonwoven fixed ends 310 along the third cleaning product upper nonwoven central portion 300 and extend to third cleaning product upper nonwoven free ends 315. A plurality of third cleaning product nonfibrous polymeric elements 320 that constitutively differ from the third cleaning product upper nonwoven 295 can be engaged with the third cleaning product upper nonwoven strips 305. The third cleaning product 235 can further comprise a third cleaning product lower nonwoven 325 and a third cleaning product intermediate nonwoven 311 between the third cleaning product upper nonwoven 295 and the third cleaning product lower nonwoven 325. The third cleaning product 235 can further comprise two third cleaning product tow fibers layers 330. One of the third cleaning product tow fibers layers 330 can be positioned between the third cleaning product upper nonwoven 295 and the third cleaning product intermediate layer 311. Another of the third cleaning product tow fibers layers 330 can be positioned between the third cleaning product lower nonwoven 325 and the third cleaning product intermediate nonwoven 311. The constituent fibers of the third cleaning product tow fibers layers 330 can be joined to one or both of the third cleaning product upper nonwoven 295 and the third cleaning product lower nonwoven 325. Optionally, the third cleaning product tow fibers layers 330 can be joined to one, two, or all three of the third cleaning product upper nonwoven 295, the third cleaning product intermediate layer 311, and the third cleaning product lower nonwoven 325. The constituent fibers of the third cleaning product tow fibers layers 330 can extend across the longitudinal axis L. The third cleaning product lower nonwoven 325 can comprise a third cleaning product lower nonwoven central portion 331 extending along the longitudinal axis L and a plurality of third cleaning product lower nonwoven strips 335 extending from the third cleaning product lower nonwoven central portion 331. The third cleaning product lower nonwoven strips 335 can comprise third cleaning product lower nonwoven fixed ends 340 along the third cleaning product lower nonwoven central portion 331 and extend to third cleaning product lower nonwoven free ends 345. The third cleaning product can optionally comprise an adhesion agent carried by one or more of the third cleaning product upper nonwoven 295, one or both of the third cleaning product tow fiber layers 330, and the third cleaning product lower nonwoven 325. The third cleaning product 235, when fluffed, can have two fluffy sides, either of which can presented to the surface being cleaned or be simultaneously presented between two surfaces being cleaned.

The fourth cleaning product 240, and parts thereof, is described previously with respect to the cleaning product 1 and FIG. 15. The fourth cleaning product 240 can comprise a fourth cleaning product floor sheet 350. The fourth cleaning product 240 can have a fourth cleaning product floor sheet area in a plane defined by the transverse edges 20 and the longitudinal edges 15. The fourth cleaning product 240 can further comprise a fourth cleaning product nonwoven substrate 355 joined to the fourth cleaning product floor sheet 350. The fourth cleaning product 240 can further comprise a plurality of fourth cleaning product nonfibrous polymeric elements 360 that constitutively differ from the fourth cleaning product nonwoven substrate 355 and are engaged with the fourth cleaning product nonwoven substrate 355. The fourth cleaning product nonwoven substrate 355 can cover from about 2% to about 40% of the fourth cleaning product floor sheet area. The fourth cleaning product 240 can further comprise a fourth cleaning product backsheet 356 and a fourth cleaning product absorbent core 357 between the fourth cleaning product floor sheet 350 and the fourth cleaning product backsheet 356. The fourth cleaning product 240 can be practical for a cleaning process in which a surface treatment composition is applied to the surface to be cleaned, for example a floor, and then wiped or scrubbed with the fourth cleaning product 240.

The fifth cleaning product 245, and parts thereof, is described previously with respect to the cleaning product 1 and FIG. 15. The fifth cleaning product 245 can comprise a fifth cleaning product floor sheet 475. The fifth cleaning product 245 can have a fifth cleaning product floor sheet area in a plane defined by the transverse edges 20 and the longitudinal edges 15. The fifth cleaning product 245 can further comprise a fifth cleaning product nonwoven substrate 480 joined to the fifth cleaning product floor sheet 475. The fifth cleaning product 245 can further comprise a plurality of fifth cleaning product nonfibrous polymeric elements 485 that constitutively differ from the fifth cleaning product nonwoven substrate 480 and are engaged with the fifth cleaning product nonwoven substrate 480. The fifth cleaning product nonwoven substrate can cover from about 2% to about 40% of the fifth cleaning product floor sheet area. The fifth cleaning product 245 can comprise a liquid surface treatment composition in contact with the fifth cleaning product floor sheet 475. The fifth cleaning product 245 can further comprise a fifth cleaning product backsheet 476 and a fifth cleaning product absorbent core 477 between the fifth cleaning product floor sheet 475 and the fifth cleaning product backsheet 476, wherein the fifth cleaning product nonwoven substrate 480 is on a side of the fifth cleaning product floor sheet 475 opposite the fifth cleaning product absorbent core 477. At least a portion of the fifth cleaning product surface treatment composition can be carried by the fifth cleaning product absorbent core 477. The fifth cleaning product 245 can be practical for a cleaning process in which surface to be cleaned is initially in an ambiently dry condition and the surface treatment composition is partially expelled from the fifth cleaning product 245 on the surface and the fifth cleaning product 245 is then wiped or scrubbed on such surface and acquires or partially acquires the spent surface treatment composition.

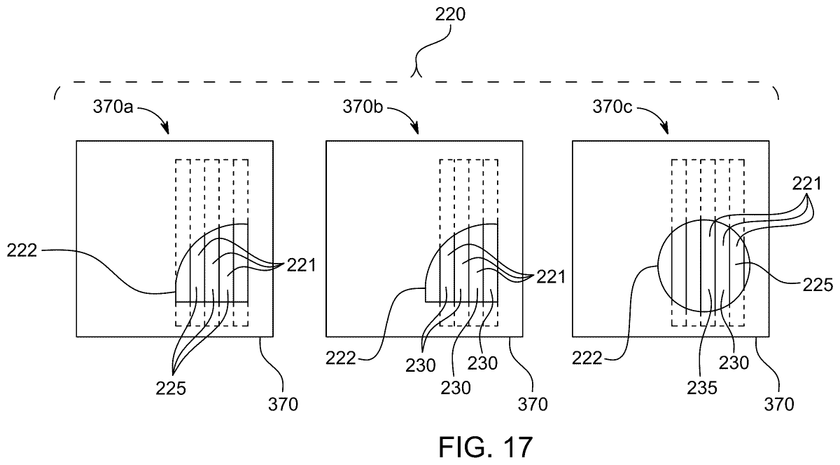

The array members that differ from one another can be together in a single package 370 (e.g. 370c) (FIG. 17). For example a package 370 may contain one or more first cleaning products 225 and one or more second cleaning products 230. Optionally, the members of the array that differ from one another can be in separate packages 370, by way of nonlimiting example packages 370a and 370b. For example, one or more first cleaning products 225 can be in a first package and one or more third cleaning products 235 can be in a second package. The separate packages 370 can be less than about 1 m apart from one another in a virtual retail environment, for example on a display screen of a device connected with the worldwide web. The separate packages 370 can be less than about 3 m, optionally less than about 2 m, optionally less than about 1 m apart from one another in a tangible, i.e. brick and mortar, retail environment. For example, the separate packages 370 may reside together on a single shelf or be shelved above and below one another in a tangible retail environment. Optionally, the members 221 of the array contained inside a package 370 or packages 370 can be visible from outside the package 370. For example, the packages 370 may have a clear or translucent portion, what is sometimes referred to as a window 222, through which the members of the array of cleaning products 220 can be observed by a human from outside the package 370.

The first cleaning product nonfibrous polymeric elements 250, the second cleaning product nonfibrous polymeric elements 280, the third cleaning product nonfibrous polymeric elements 320, the fourth cleaning product nonfibrous polymeric elements 360, and the fifth cleaning product nonfibrous polymeric elements 485, can have the same color as one another, and optionally be compositionally the same as one another. Optionally, they can be compositionally the same as one another and differ in color from one another. For example, the first cleaning product nonfibrous polymeric elements 250 and the second cleaning product nonfibrous polymeric elements 280 can have the same color as one another. These features can have the same color since they can provide for the same function and make that feature and commonality of function easily recognized by the user. Similarly, these nonfibrous polymeric elements can have the same size and shape as one another for the same reasons. Differences in color of the nonfibrous polymeric elements can help the shopper identify that there is a difference in structure and or function of the cleaning products 1. Optionally, each of the aforesaid features can comprise porous ink.

Optionally, at least one of the first cleaning product nonfibrous polymeric elements, the second cleaning product nonfibrous polymeric elements, the third cleaning product nonfibrous polymeric elements, the fourth cleaning product nonfibrous polymeric elements, and the fifth cleaning product nonfibrous polymeric elements has a color that is not the same as the others. This can help the user differentiate amongst the different products based on the color of the nonfibrous polymeric elements.

Optionally, the first cleaning product nonfibrous polymeric elements 250, the second cleaning product nonfibrous polymeric elements 280, the third cleaning product nonfibrous polymeric elements 320, the fourth cleaning product nonfibrous polymeric elements 360, and the fifth cleaning product nonfibrous polymeric elements 485 can differ in color from one another. The difference in color might help the user identify that the cleaning products differ from one another and draw the user's attention to focus on selecting the right cleaning product for the job to be done.

The array of cleaning products 220 can comprise at least three members selected from, selected from the group of, or selected from the group consisting of the first cleaning product 225, the second cleaning product 230, and the third cleaning product 235. Such an array of cleaning products 220 is practical in that each of these cleaning products 1 can used in an ambiently dry condition on an ambiently dry surface.

### Combinations

An Example is below:
A. A cleaning product (1) comprising:
a first nonwoven (5);
a first plurality of nonfibrous polymeric elements (45) that constitutively differs from said first nonwoven, wherein members of said first plurality of nonfibrous polymeric elements are engaged with said first nonwoven and project outwardly away from said first nonwoven, and wherein members of said first plurality of nonfibrous polymeric indicia are sized and dimensioned to provide a pattern created volume from about 0.2 mm to about 1 mm; and
an adhesion agent carried by said first nonwoven, wherein said adhesion agent is selected from the group of oil, wax, adhesive, and combinations thereof.
B. The cleaning product according to Paragraph A, wherein said adhesion agent is mineral oil.
C. The cleaning product according to Paragraph A, wherein said adhesion agent is wax.
D. The cleaning product according to any of Paragraphs A to C, wherein said cleaning product further comprises a triglyceride and a silicone wax carried by said first nonwoven.
E. The cleaning product according to any of Paragraphs A to D, wherein said first nonwoven comprises: a first nonwoven central portion (10) along a longitudinal axis (L); and a plurality of first nonwoven strips (25) extending from said first nonwoven central portion; wherein said first nonwoven strips comprise first nonwoven fixed ends (30) along said first nonwoven central portion and extend to first nonwoven free ends (35), and wherein members of said first plurality of nonfibrous polymeric elements are engaged with said first nonwoven strips.
F. The cleaning product according to Paragraph E, wherein said first nonwoven has a first configuration in which said first nonwoven strips are in plane with one another and a second configuration in which a majority of said first nonwoven strips are bent out of plane about said first nonwoven fixed ends.
G. The cleaning product according to Paragraph F, wherein said first nonwoven strips comprise lateral edges (40) extending from said first nonwoven fixed ends to said first nonwoven free ends, and wherein in said second configuration at least some of said lateral edges are engaged with one or more said nonfibrous polymeric elements of a neighboring said first nonwoven strip.
H. The cleaning product according to any of Paragraphs E to G, wherein said cleaning product further comprises a second layer (105) joined directly or indirectly to said first nonwoven central portion, optionally wherein said second layer is joined directly or indirectly to said first nonwoven central portion along a bond (107), optionally wherein said bond is coincident with at least some nonfibrous polymeric elements.
I. The cleaning product according to Paragraph H, wherein said second layer comprises a second layer central portion (110) along said longitudinal axis, a plurality of second layer strips (125) extending from said second layer central portion, and wherein said second layer strips comprise second layer fixed ends (130) along said second layer central portion and extend to second layer free ends (135).
J. The cleaning product according to Paragraph I, wherein said cleaning product further comprises a second plurality of nonfibrous polymeric elements (145) that constitutively differs from said second layer and members of said second plurality of nonfibrous polymeric elements are engaged with said second layer strips, optionally wherein members of said second plurality of nonfibrous polymeric elements are oriented in a direction away from said first nonwoven.
K. The cleaning product according to Paragraph I or J, wherein said second layer has a first configuration in which said second layer strips are in plane with one another and a second configuration in which a majority of said second layer strips are bent out of plane about said second layer fixed ends.
L. The cleaning product according to any of Paragraphs I to K, wherein said second layer strips extend further away from said longitudinal axis than said first layer strips extend away from said longitudinal axis.
M. The cleaning product according to any of Paragraphs H to L,
wherein said first nonwoven has a first configuration in which said first nonwoven strips are in plane with one another and a second configuration in which a majority of said first nonwoven strips are bent out of plane about said first nonwoven fixed ends, and wherein in said second configuration fewer members of said first plurality of nonfibrous polymeric elements are oriented away from said second layer than in said first configuration.
N. The cleaning product according to any of Paragraphs H to M, wherein an intermediate layer (411) is between said first nonwoven and said second layer.
O. The cleaning product according to any of Paragraphs H to N, wherein said second layer extends from said first nonwoven at a fold line (62) between said first nonwoven and said second layer.
P. The cleaning product according to any of Paragraphs H to O, wherein said cleaning product further comprises a tow fibers layer (155) positioned between said first nonwoven and said second layer, wherein constituent fibers of said tow fibers layer extend across said longitudinal axis, wherein said bond includes said tow fibers layer.
Q. The cleaning product according to Paragraph P, wherein said first nonwoven has a first configuration in which said first nonwoven strips are in plane with one another and a second configuration in which a majority of said first nonwoven strips are bent out of plane about said first nonwoven fixed ends, wherein said first nonwoven strips comprise lateral edges (40) extending from said first nonwoven fixed ends to said first nonwoven free ends, and wherein in said second configuration at least some members of said first plurality of nonfibrous polymeric elements are engaged with said tow fibers layer.
R. The cleaning product according to any of Paragraphs H to Q, wherein said cleaning product has a longitudinal axis (L) between opposing transverse edges (20) that cross said longitudinal axis and longitudinal edges (15) spaced apart from said longitudinal axis and extending between said transverse edges, wherein said first nonwoven has a first nonwoven downwardly facing surface (50) extending from said longitudinal axis to said first nonwoven free ends and oriented away from said second layer, and wherein said first plurality of nonfibrous polymeric elements is engaged with said first nonwoven downwardly facing surface of said first nonwoven strips.
S. The cleaning product according to any of Paragraphs E to R, wherein each of said first nonwoven strips has a strip mass, wherein members of said first plurality of nonfibrous polymeric elements on an individual first nonwoven strip have a cumulative nonfibrous polymeric elements mass, and wherein said cumulative nonfibrous polymeric elements mass is from about 1% to about 60% of said strip mass.
T. The cleaning product according to any of Paragraphs E to S, wherein said first nonwoven strips comprise lateral edges (40) extending from said first nonwoven fixed ends to said first nonwoven free ends, and wherein said lateral edges intercept one or more members of said first plurality of nonfibrous polymeric elements.
U. The cleaning product according to any of Paragraphs A to T, wherein said first plurality of nonfibrous polymeric elements has a freestanding cumulative volume beyond said first nonwoven less than 0.025 mm³/mm².
V. The cleaning product according to any of Paragraphs A to U, wherein members of said first plurality of nonfibrous polymeric elements comprise ink.
W. The cleaning product according to any of Paragraphs A to V, wherein said cleaning product has a longitudinal axis (L) between opposing transverse edges (20) that cross said longitudinal axis and longitudinal edges (15) spaced apart from said longitudinal axis and extending between said transverse edges, wherein said cleaning product comprises a transverse axis (T) orthogonal to said longitudinal axis.
X. The cleaning product according to any of Paragraphs A to W, wherein said cleaning product comprises from about 0.5 g/m² to about 30 g/m²of said first plurality of nonfibrous polymeric elements.
Y. The cleaning product according to any of Paragraphs A to X, wherein at least some members of said first plurality of nonfibrous polymeric elements comprise a substantially flat surface (60) substantially parallel to said first nonwoven.
Z. The cleaning product according to any of Paragraphs A to Y, wherein members of said first plurality of nonfibrous polymeric elements are sized and dimensioned to provide a pattern created volume of from about 0.2 mm to about 1 mm.
AA. The cleaning product according to any of Paragraphs A to Z, wherein members of said first plurality of nonfibrous polymeric elements comprise a porous ink.
BB. The cleaning product according to any of Paragraphs A to AA, wherein members of said first plurality of nonfibrous polymeric elements comprise:
an acrylic copolymer of styrene, butyl acrylate, and acrylonitrile; and
an acrylic copolymer of styrene, butyl acrylate, ethyl acrylate, and acrylic acid.
CC. The cleaning product according to any of Paragraphs A to BB, wherein said first nonwoven has a plastic content from about 0% to about 10% by weight of said first nonwoven.
DD. The cleaning product according to Paragraph A, wherein said cleaning product further comprises a tow fibers layer (155) joined to said first nonwoven.
EE. The cleaning product according to Paragraph DD, wherein said cleaning product (1) has a longitudinal axis (L) between opposing transverse edges (20) that cross said longitudinal axis and longitudinal edges (15) spaced apart from said longitudinal axis and extending between said transverse edges, wherein constituent fibers of said tow fibers layer extend across said longitudinal axis, optionally wherein said first nonwoven is joined to said tow fibers layer by a bond at least partially coincident with said longitudinal axis, coincident with said longitudinal axis, or parallel to said longitudinal axis.
FF. A cleaning product (1) comprising:
a first nonwoven (5);
a first plurality of nonfibrous polymeric elements (45) that constitutively differs from said first nonwoven, wherein members of said first plurality of nonfibrous polymeric elements are engaged with said first nonwoven and project outwardly away from said first nonwoven; and
a second layer (105) joined directly or indirectly to said first nonwoven, wherein said second layer comprises a second layer central portion (110) along a longitudinal axis, a plurality of second layer strips (125) extending from said second layer central portion, wherein said second layer strips comprise second layer fixed ends (130) along said second layer central portion and extend to second layer free ends (135).
GG. The cleaning product according to Paragraph FF, wherein said cleaning product further comprises a second plurality of nonfibrous polymeric elements (145) that constitutively differs from said second layer and is engaged with said second layer strips, optionally wherein said second plurality of nonfibrous polymeric elements is oriented in a direction away from said first nonwoven.
HH. The cleaning product according to Paragraph FF or GG, wherein members of said first plurality of nonfibrous polymeric indicia are sized and dimensioned to provide a pattern created volume from about 0.2 mm to about 1 mm.
II. The cleaning product according to any of Paragraphs FF to HH, wherein said second layer has a first configuration in which said second layer strips are in plane with one another and a second configuration in which a majority of said second layer strips are bent out of plane about said second layer fixed ends.
JJ. The cleaning product according to any of Paragraphs FF or II, wherein said second layer has a second layer downwardly facing surface (150) oriented towards said first nonwoven, and wherein said second plurality of nonfibrous polymeric elements is on or in said second layer downwardly facing surface.
KK. The cleaning product according to any of Paragraphs FF to JJ, wherein said second layer strips extend further away from said longitudinal axis than said first nonwoven.
LL. The cleaning product according to any of Paragraphs FF to KK, wherein said first nonwoven has a first nonwoven downwardly facing surface (50) oriented towards said second layer, and wherein said first plurality of nonfibrous polymeric elements is engaged with said first nonwoven downwardly facing surface.
MM. The cleaning product according to Paragraph LL, wherein said first plurality of nonfibrous polymeric elements projects outwardly away from said first nonwoven downwardly facing surface.
NN. The cleaning product according to Paragraph MM, wherein said first plurality of nonfibrous polymeric elements has a freestanding cumulative volume beyond said first nonwoven downwardly facing surface of from about 0.005 mm³/mm² to about 0.025 mm³/mm².

With respect to any ranges articulated within this patent application, whole number ranges and decimal ranges within the articulated ranges, are contemplated. For example, within a range of about 1 to about 10, the range of about 3 to about 4 is contemplated. Within a range of about 0.5 to about 3, the ranges of about 0.7 to about 1.5, about 0.75 to about 1, and about 0.55 to about 0.85 are contemplated.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning product comprising:
a first nonwoven;
a first plurality of nonfibrous polymeric elements that constitutively differs from said first nonwoven, wherein members of said first plurality of nonfibrous polymeric elements are engaged with said first nonwoven and project outwardly away from said first nonwoven, and wherein members of said first plurality of nonfibrous polymeric indicia are sized and dimensioned to provide a pattern created volume from about 0.2 mm to about 1 mm; and
an adhesion agent carried by said first nonwoven, wherein said adhesion agent is selected from the group of oil, wax, adhesive, and combinations thereof.

2. The cleaning product according to claim 1, wherein said adhesion agent is mineral oil.

3. The cleaning product according to claim 1, wherein said adhesion agent is wax.

4. The cleaning product according to claim 1, wherein said cleaning product further comprises a triglyceride carried by said first nonwoven and a silicone wax carried by said first nonwoven.

5. The cleaning product according to claim 1, wherein said first nonwoven comprises a first nonwoven central portion along a longitudinal axis, a plurality of first nonwoven strips extending from said first nonwoven central portion, wherein said first nonwoven strips comprise first nonwoven fixed ends along said first nonwoven central portion and extend to first nonwoven free ends, and wherein members of said first plurality of nonfibrous polymeric elements are engaged with said first nonwoven strips.

6. The cleaning product according to claim 5, wherein said first nonwoven has a first configuration in which said first nonwoven strips are in plane with one another and a second configuration in which a majority of said first nonwoven strips are bent out of plane about said first nonwoven fixed ends.

7. The cleaning product according to claim 6, wherein said first nonwoven strips comprise lateral edges extending from said first nonwoven fixed ends to said first nonwoven free ends, wherein in said second configuration at least some of said lateral edges are engaged with one or more said nonfibrous polymeric elements of a neighboring said first nonwoven strip.

8. The cleaning product according to claim 5, wherein said cleaning product further comprises a second layer joined directly or indirectly to said first nonwoven central portion along a bond, wherein said bond is coincident with at least some nonfibrous polymeric elements.

9. The cleaning product according to claim 8, wherein said second layer comprises a second layer central portion along said longitudinal axis, a plurality of second layer strips extending from said second layer central portion, wherein said second layer strips comprise second layer fixed ends along said second layer central portion and extend to second layer free ends.

10. The cleaning product according to claim 9, wherein said cleaning product further comprises a second plurality of nonfibrous polymeric elements that constitutively differs from said second layer and members of said second plurality of nonfibrous polymeric elements are engaged with said second layer strips, wherein members of said second plurality of nonfibrous polymeric elements are oriented in a direction away from said first nonwoven.

11. The cleaning product according to claim 8, wherein said cleaning product further comprises a tow fibers layer positioned between said first nonwoven and said second layer, wherein constituent fibers of said tow fibers layer extend across said longitudinal axis, wherein said bond includes said tow fibers layer.

12. The cleaning product according to claim 11, wherein said first nonwoven has a first configuration in which said first nonwoven strips are in plane with one another and a second configuration in which a majority of said first nonwoven strips are bent out of plane about said first nonwoven fixed ends, wherein said first nonwoven strips comprise lateral edges extending from said first nonwoven fixed ends to said first nonwoven free ends, wherein in said second configuration at least some of said first plurality of nonfibrous polymeric elements are engaged with said tow fibers layer.

13. The cleaning product according to claim 5, wherein said first nonwoven strips comprise lateral edges extending from said first nonwoven fixed ends to said first nonwoven free ends, wherein said lateral edges intercept one or more members of said first plurality of nonfibrous polymeric elements.

14. The cleaning product according to claim 1, wherein said first plurality of nonfibrous polymeric elements has a freestanding cumulative volume beyond said first nonwoven less than 0.025 mm³/mm².

15. The cleaning product according to claim 1, wherein members of said first plurality of nonfibrous polymeric elements comprise ink.

16. The cleaning product according to claim 1, wherein said cleaning product has a longitudinal axis between opposing transverse edges that cross said longitudinal axis and longitudinal edges spaced apart from said longitudinal axis and extending between said transverse edges, wherein said cleaning product comprises a transverse axis orthogonal to said longitudinal axis, and wherein said cleaning product is folded about said transverse axis such that portions of said first nonwoven on opposite sides of said transverse axis are in face to face relationship with one another.

17. The cleaning product according to claim 1, wherein at least some members of said first plurality of nonfibrous polymeric elements comprise a substantially flat surface substantially parallel to said first nonwoven.

18. The cleaning product according to claim 1, wherein members of said first plurality of nonfibrous polymeric elements comprise a porous ink.

19. The cleaning product according to claim 1, wherein said cleaning product further comprises a tow fibers layer joined to said first nonwoven, wherein constituent fibers of said tow fibers layer extend across said longitudinal axis.

20. A cleaning product comprising:
a first nonwoven;
a first plurality of nonfibrous polymeric elements that constitutively differs from said first nonwoven, wherein members of said first plurality of nonfibrous polymeric elements are engaged with said first nonwoven and project outwardly away from said first nonwoven; and
a second layer joined directly or indirectly to said first nonwoven, wherein said second layer comprises a second layer central portion along a longitudinal axis, a plurality of second layer strips extending from said second layer central portion, wherein said second layer strips comprise second layer fixed ends along said second layer central portion and extend to second layer free ends.
